(19) United States
(12) Patent Application Publication
(10) Pub. No.: US 2014/0114584 A1
(43) Pub. Date: Apr. 24, 2014

(54) METHODS AND SYSTEMS FOR IDENTIFYING, FROM READ SYMBOL SEQUENCES, VARIATIONS WITH RESPECT TO A REFERENCE SYMBOL SEQUENCE

(71) Applicant: Spiral Genetics Inc., Seattle, WA (US)

(72) Inventor: Jeremy J. Bruestle, Seattle, WA (US)

(73) Assignee: Spiral Genetics Inc., Seattle, WA (US)

(21) Appl. No.: 14/048,596

(22) Filed: Oct. 8, 2013

Related U.S. Application Data
(60) Provisional application No. 61/711,147, filed on Oct. 8, 2012.

(51) Int. Cl. G06F 19/22

(52) U.S. Cl. CPC G06F 19/22
USPC 702/20

(57) ABSTRACT

The current document is directed to automated methods and processor-controlled systems for assembling short read symbol sequences into longer assembled symbol sequences that are aligned and compared to a reference symbol sequence in order to determine differences between the longer assembled symbol sequences and the reference sequence. These methods and systems are applied to process electronically stored symbol-sequence data. While the symbol-sequence data may represent genetic-code data, the automated methods and processor-controlled systems may be more generally applied to various different symbol-sequence data. In certain implementations, redundancy in read symbol sequences is used to preprocess the read symbol sequences to identify and correct symbol errors. In certain implementations, those corrected read symbol sequences that exactly match subsequences of the reference symbol sequence are identified and removed from subsequent processing steps, to simply the identification of differences between the longer assembled symbol sequences and the reference sequence.

### CROSS-REFERENCE TO RELATED APPLICATION

This application claims the benefit of Provisional Application No. 61/711,147, filed Oct. 8, 2012.

### TECHNICAL FIELD

The current application is directed to automated processing of read symbol sequences to identify variations between a sequence assembled from overlapping read sequences and a reference symbol sequence.

### BACKGROUND

Since the 1950's, when the there-dimensional structures of genetic biopolymers were elucidated, enormous strides have been made in determining and analyzing the genetic codes, incorporated within genetic biopolymers, of many different types of organisms, including humans. It is now possible to determine the entire genetic code for individual organisms in a matter of days at costs below $10,000. As genetic-code determination becomes commercially widespread and routinely used in medical diagnostics, it is anticipated that very large amounts of genetic-code data will need to be computationally processed in order to extract relevant diagnostic information. Additionally, scientific research already generates vast amounts of genetic-code information. Currently, the computational processing of this information represents an increasingly severe bottleneck in using genetic-code information for scientific research. As a result, clinicians and diagnosticians, scientific researchers, bioinformatics-software and bioinformatics-systems designers and venders, and many others continue to seek new and efficient computational methods and systems for processing symbol-sequences.

### SUMMARY

The current document is directed to automated methods and processor-controlled systems for assembling short read symbol sequences into longer assembled symbol sequences that are aligned and compared to a reference symbol sequence in order to determine differences between the longer assembled symbol sequences and the reference sequence. These methods and systems are applied to process electronically stored symbol-sequence data. While the symbol-sequence data may represent genetic-code data, the automated methods and processor-controlled systems may be more generally applied to various different symbol-sequence data. In certain implementations, redundancy in read symbol sequences is used to preprocess the read symbol sequences to identify and correct symbol errors. In certain implementations, those corrected read symbol sequences that exactly match subsequences of the reference symbol sequence are identified and removed from subsequent processing steps, to simply the identification of differences between the longer assembled symbol sequences and the reference sequence.

### BRIEF DESCRIPTION OF THE DRAWINGS

FIG. 1 illustrates a short DNA polymer.

FIGS. 2A-B illustrate hydrogen bonding between the purine and pyrimidine bases of two anti-parallel DNA strands.

FIG. 3 illustrates a short section of a DNA double helix 300 comprising a first strand 302 and a second, anti-parallel strand 304.

FIG. 4 illustrates illustration conventions used in the following discussion in the current subsection as well as in the third subsection.

FIG. 5 shows multiple copies 502-508 of an anti-parallel symbol-sequence pair that may represent multiple copies of a genome sequence.

FIG. 6 illustrates generation of reads from a symbol sequence.

FIG. 7 illustrates computational processing of read symbol sequences to assemble a symbol sequence corresponding to the symbol sequence from which the reads were initially generated.

FIGS. 8-11B illustrate one computational method for assembling reads to produce an initial symbol sequence from which the reads were generated.

FIG. 12 illustrates quality scores often associated with symbols of a symbol sequence produced by chemical and/or instrumental sequencing methodologies.

FIG. 13 illustrates certain of various types of genetic variants that are observed in organisms, including humans.

FIG. 14 illustrates detection of a deletion by read assembly.

FIG. 15 illustrates k-merization of reads.

FIG. 16 shows a table of the unique k-mers generated by k-merization of reads 1502-1504, shown in FIG. 15.

FIG. 17 illustrates the range of k-mer scores that can be observed for 23-symbol k-mers.

FIG. 18 shows a generalized distribution of k-mer scores observed for actual genome-sequencing procedures.

FIG. 19A-G illustrate a De Bruijn graph and threading of a read into a De Bruijn graph.

FIGS. 20A-E illustrate the parallel threading process for read correction.

FIGS. 21A-G illustrate use corrected reads to assemble a variant symbol subsequence at a position of a reference symbol sequence.

FIGS. 22A-J provide control-flow diagrams that illustrate a variant-detection control program that, when executed by one or more processors of a processor-controlled system, implement a method of variant detection to which the current document is directed.

FIG. 23 provides a general architectural diagram for various types of computers and other processor-controlled devices.

### DETAILED DESCRIPTION

The current document is directed to automated methods and processor-controlled systems for assembling short read symbol sequences into longer assembled symbol sequences that are aligned and compared to a reference symbol sequence in order to determine differences between the longer assembled symbol sequences and the reference sequence. These methods and systems are applied to process electronically stored symbol-sequence data. While the symbol-sequence data may represent genetic-code data, the automated methods and processor-controlled systems may be more generally applied to various different symbol-sequence data. Thus, the current document is directed to automated methods and processor-controlled systems for processing and generating electronically stored data, including symbol sequences. In the following discussion, genetic codes and genetic biopolymers are first introduced in a first subsection. A second subsection discusses the general problem domain of variant detection. A third subsection includes a detailed description of the automated methods and processor-controlled systems to which the current document is directed.

### Genetic Codes and Genetic Biopolymers

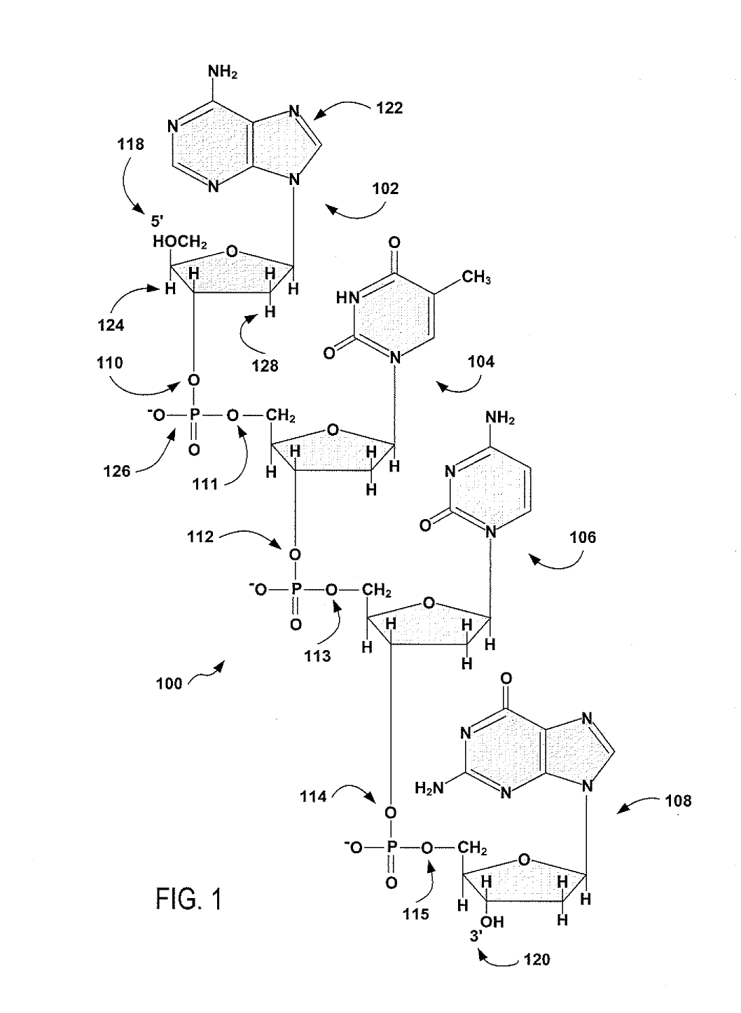

FIG. 1 illustrates a short DNA polymer. Deoxyribonucleic acid (“DNA”) and ribonucleic acid (“RNA”) are linear polymers, each synthesized from four different types of subunit molecules. The subunit molecules for DNA include: (1) deoxy-adenosine, abbreviated “A,” a purine nucleoside; (2) deoxy-thymidine, abbreviated “T,” a pyrimidine nucleoside; (3) deoxy-cytosine, abbreviated “C,” a pyrimidine nucleoside; and (4) deoxy-guanosine, abbreviated “G,” a purine nucleoside. The subunit molecules for RNA include: (1) adenosine, abbreviated “A,” a purine nucleoside; (2) uracil, abbreviated “U,” a pyrimidine nucleoside; (3) cytosine, abbreviated “C,” a pyrimidine nucleoside; and (4) guanosine, abbreviated “G,” a purine nucleoside. FIG. 1 illustrates a short DNA polymer 100, called an oligomer, composed of the following subunits: (1) deoxy-adenosine 102; (2) deoxy-thymidine 104; (3) deoxy-cytosine 106; and (4) deoxy-guanosine 108. When phosphorylated, subunits of DNA and RNA molecules are called “nucleotides” and are linked together through phosphodiester bonds 110-115 to form DNA and RNA polymers. A linear DNA molecule, such as the oligomer shown in FIG. 1, has a 5′ end 118 and a 3′ end 120. A DNA polymer can be chemically characterized by writing, in sequence from the 5′ end to the 3′ end, the single letter abbreviations for the nucleotide subunits that together compose the DNA polymer. For example, the oligomer 100 shown in FIG. 1 can be chemically represented as “ATCG.” A DNA nucleotide comprises a purine or pyrimidine base (e.g. adenine 122 of the deoxy-adenylate nucleotide 102), a deoxy-ribose sugar (e.g. deoxy-ribose 124 of the deoxy-adenylate nucleotide 102), and a phosphate group (e.g. phosphate 126) that links one nucleotide to another nucleotide in the DNA polymer. In RNA polymers, the nucleotides contain ribose sugars rather than deoxy-ribose sugars. In ribose, a hydroxyl group takes the place of the 2′ hydrogen 128 in a DNA nucleotide. RNA polymers contain uridine nucleosides rather than the deoxy-thymidine nucleosides contained in DNA. The pyrimidine base uracil lacks a methyl group (130 in FIG. 1) contained in the pyrimidine base thymine of deoxy-thymidine.

The DNA polymers that contain the organization information for living organisms occur in the nuclei of cells in pairs, forming double-stranded DNA helixes. One polymer of the pair is laid out in a 5′ to 3′ direction, and the other polymer of the pair is laid out in a 3′ to 5′ direction. The two DNA polymers in a double-stranded DNA helix are therefore described as being anti-parallel. The two DNA polymers, or strands, within a double-stranded DNA helix are bound to each other through attractive forces including hydrophobic interactions between stacked purine and pyrimidine bases and hydrogen bonding between purine and pyrimidine bases, the attractive forces emphasized by conformational constraints of DNA polymers. Because of a number of chemical and topographic constraints, double-stranded DNA helices are most stable when deoxy-adenylate subunits of one strand hydrogen bond to deoxy-thymidylate subunits of the other strand, and deoxy-guanylate subunits of one strand hydrogen bond to corresponding deoxy-cytidilate subunits of the other strand.

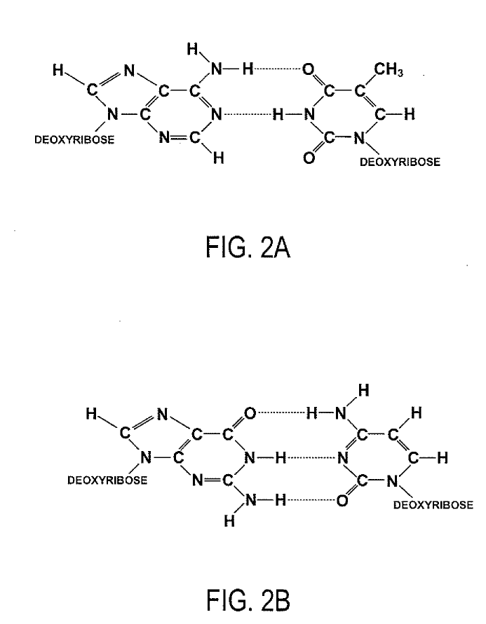

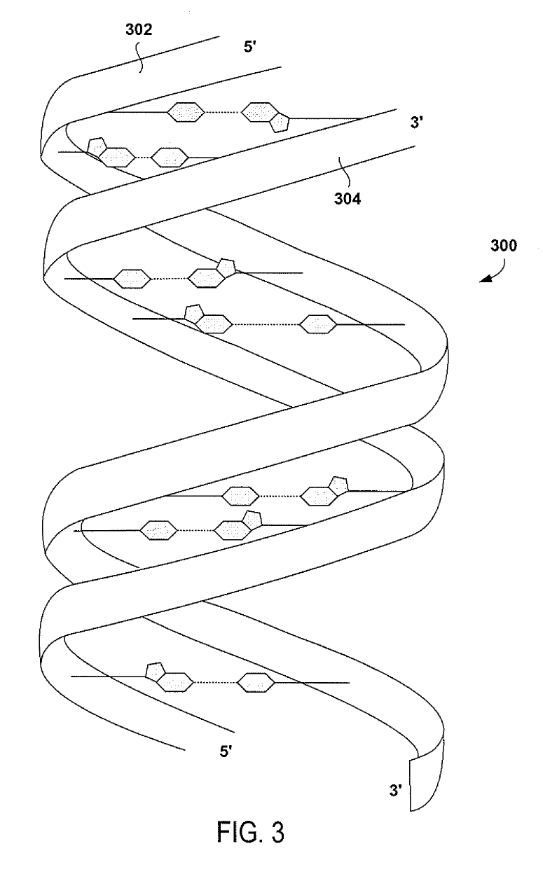

FIGS. 2A-B illustrate the hydrogen bonding between the purine and pyrimidine bases of two anti-parallel DNA strands. FIG. 2A shows hydrogen bonding between adenine and thymine bases of corresponding adenosine and thymidine subunits, and FIG. 2B shows hydrogen bonding between guanine and cytosine bases of corresponding guanosine and cytosine subunits. Note that there are two hydrogen bonds 202 and 203 in the adenine/thymine base pair, and three hydrogen bonds 204-206 in the guanosine/cytosine base pair, as a result of which GC base pairs contribute greater thermodynamic stability to DNA duplexes than AT base pairs. AT and GC base pairs, illustrated in FIGS. 2A-B, are known as Watson-Crick (“WC”) base pairs.

Two DNA strands linked together by hydrogen bonds forms the familiar helix structure of a double-stranded DNA helix. FIG. 3 illustrates a short section of a DNA double helix 300 comprising a first strand 302 and a second, anti-parallel strand 304. The ribbon-like strands in FIG. 3 represent the deoxyribose and phosphate backbones of the two anti-parallel strands, with hydrogen-bonding purine and pyrimidine base pairs, such as base pair 306, interconnecting the two strands. Deoxy-guanylate subunits of one strand are generally paired with deoxy-cytidilate subunits from the other strand, and deoxy-thymidilate subunits in one strand are generally paired with deoxy-adenylate subunits from the other strand. However, non-WC base pairings may occur within double-stranded DNA. Generally, purine/pyrimidine non-WC base pairings contribute little to the thermodynamic stability of a DNA duplex, but generally do not destabilize a duplex otherwise stabilized by WC base pairs. However, purine/purine base pairs may destabilize DNA duplexes.

Double-stranded DNA may be denatured, or converted into single stranded DNA, by changing the ionic strength of the solution containing the double-stranded DNA or by raising the temperature of the solution. Single-stranded DNA polymers may be renatured, or converted back into DNA duplexes, by reversing the denaturing conditions, for example by lowering the temperature of the solution containing complementary single-stranded DNA polymers. During renaturing or hybridization, complementary bases of anti-parallel DNA strands form WC base pairs in a cooperative fashion, leading to regions of DNA duplex. Strictly A-T and G-C complementarity between anti-parallel polymers leads to the greatest thermodynamic stability, but partial complementarity including non-WC base pairing may also occur to produce relatively stable associations between partially-complementary polymers. In general, the longer the regions of consecutive WC base pairing between two nucleic acid polymers, the greater the stability of hybridization between the two polymers under renaturing conditions.

The DNA in living organisms occurs as extremely long double-stranded DNA polymers known as chromosomes. Each chromosome may contain millions of base pairs. The base-pair sequence in a chromosome is logically viewed as a set of long subsequences that include regulatory regions to which various biological molecules may bind, structural regions consisting of repeated short sequences, and genes. A gene generally encodes the amino-acid sequence of a protein, with base-pair triples within the exon region of a gene coding for specific amino acids within the protein.

When cells divide, the double-stranded chromosomes are replicated in a process logically equivalent to separating the two DNA strands of a chromosome and synthesizing a new, complementary strand for each of the two separated strands, resulting in two chromosomes, each containing an original strand and a newly synthesized strand. DNA synthesis is carried out by the enzyme DNA polymerase. This enzyme polymerizes nucleotide triphosphate monomers into a DNA polymer complementary to a DNA polymer that serves as a template for the DNA polymerase.

Chromosomes are transcribed in an organism by an RNA polymerase to produce messenger RNA molecules (“mRNA”) that, in turn, serve as templates for translation of the base-pair sequence of the mRNA into protein molecules. The amino-acid sequence of protein molecules is thus determined by the base-pair sequence of the messenger RNA, which is, in turn, complementary to, and determined by, the base-pair sequence within a corresponding gene.

In general, the organisms within a species commonly share the DNA sequences of the genes contained within their chromosomes. However, slight variations of gene sequences occur within the individuals of each species. These slight variations are reflected in the biochemical and physical characteristics of individuals of the species. Hair color, eye color, growth patterns, disease susceptibility, metabolism, and many other characteristics that vary among individuals of a species are attributable to variations in gene sequences. In addition, non-protein-coding regions of the genome are also shared, in some cases as conservatively or more conservatively as protein-coding regions, and, in other cases, less conservatively. Sequence differences in non-protein-coding regions between individuals may also lead to observably different traits and characteristics of the individuals. For example, genes are generally associated with DNA control sequences that provide a basis for transcriptional control of gene expression. A modified control region may as effectively lead to low concentrations or the absence of a protein function as a serious mutation in the gene encoding the protein.

### Variant Detection

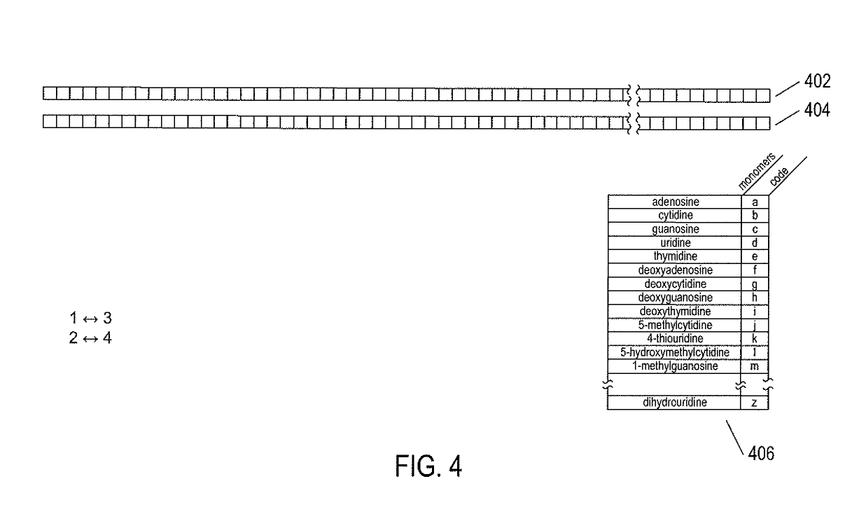

FIG. 4 illustrates illustration conventions used in the following discussion in the current subsection as well as in the third subsection, below. The current document is concerned with automated methods and processor-controlled systems that process electronically stored data, including symbol sequences. While these automated methods and processor-controlled systems are described, below, in the context of genetic data, they are more generally applicable. In FIG. 4, two anti-parallel symbol sequences 402 and 404 represent the encoding of a genome or partial genome. The two anti-parallel symbol sequences 402 and 404 contain complementary symbols, such as the complementary base pairs A-T and G-C. Although many genomes, including the human genome, are distributed over multiple chromosomes and additional biopolymers, including mitochondrial DNA, it is assumed, for simplicity of description and illustration, that the multiple separate sequences can be concatenated to produce a single, linear sequence. In order to electronically encode the monomer sequences of biopolymers, a small-integer or character encoding for each of the various different types of monomers can be employed. In FIG. 4, a table of monomer encodings 406 is shown. Different types of biopolymers include different types of monomers. The table 406 shown in FIG. 4 includes encodings for the common monomers found in DNA and RNA as well as additional monomers found in genetic biopolymers. Because the currently described computational methods and system operate on electronically encoded and stored symbol sequences, the identities of the particular types of sequences and chemical meaning of the symbol encodings is largely irrelevant. In the following discussion, the symbol sequences include four different symbols 1, 2, 3, and 4. In aligned, anti-parallel, complementary symbol sequences, such as symbol sequences 402 and 404, symbol 1 in a first position of a first sequence occurs across from, and aligned with, symbol 3 in a complementary position of the second sequence. Similarly, symbol 2 in a first position of a first sequence occurs across from, and aligned with, symbol 4 in a complementary position of the second sequence. The symbols 1, 2, 3, and 4 may represent particular monomers of a particular type of biopolymer, but may also represent other types of sequentially-encoded information. The methods described below do not depend on the numeric symbols representing any particular chemical or non-chemical entity.

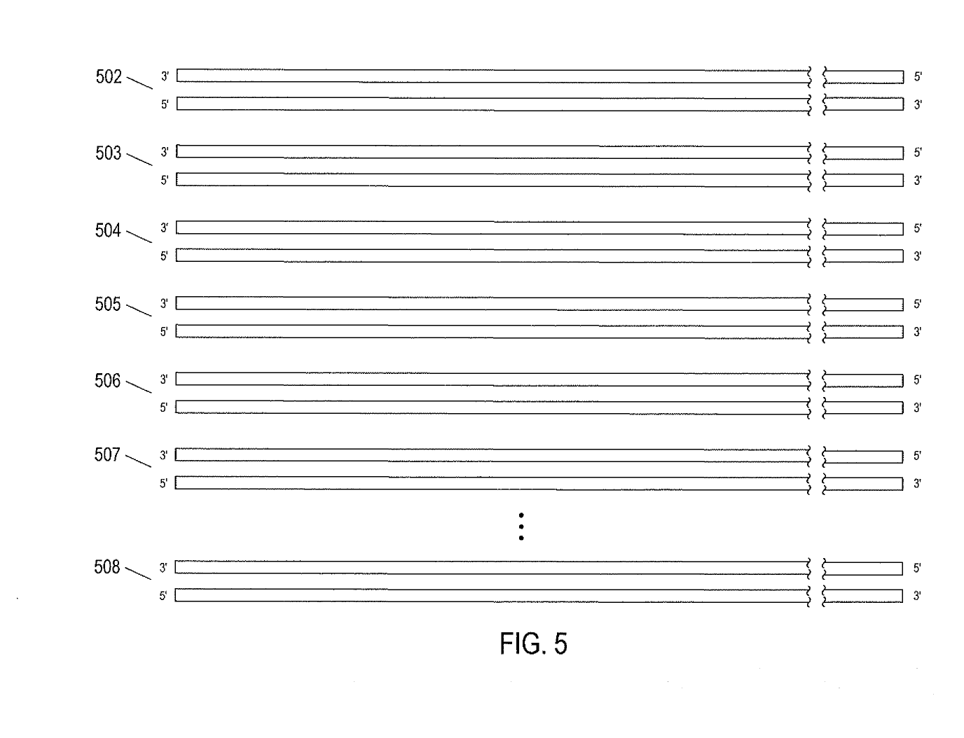

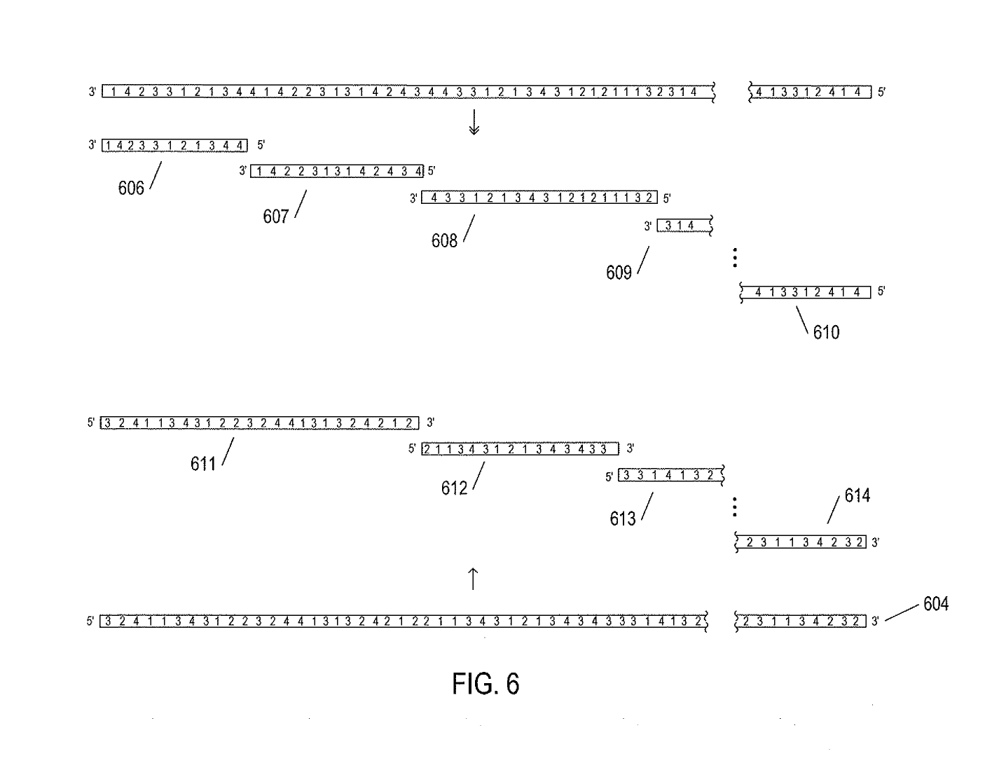

In certain types of genome-sequencing methods, multiple copies a genome are sequenced. FIG. 5 shows multiple copies 502-508 of an anti-parallel symbol-sequence pair that may represent multiple copies of a genome sequence. FIG. 6 illustrates generation of reads from a symbol sequence. As shown in FIG. 6, in the genome-sequencing methods, each symbol sequence 602 and 604 of each anti-parallel symbol-sequence pair can be thought of as being cut, or partitioned, into a large number of small subsequences 606-614, referred to as “reads,” the sequences for which are then determined by any of various chemical and/or instrumental methods. The positions at which the original symbol sequences are cut are not fixed or predetermined, and generally differ for symbol sequence of each anti-parallel symbol-sequence pair. Thus, as a result of a sequencing procedure, a very large number of read symbol sequences are obtained. In certain types of procedures, reads on the order of 100 monomers in length are produced. For a human genome, many tens of millions to hundreds of millions of different reads may be generated in a sequencing procedure.

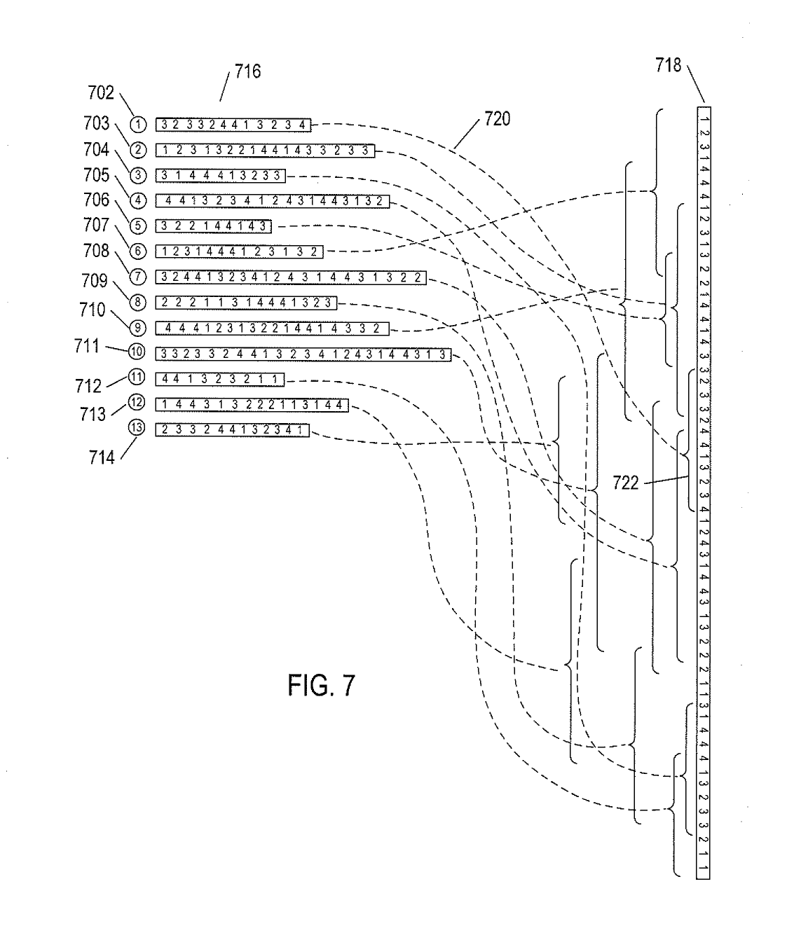

FIG. 7 illustrates computational processing of read symbol sequences to assemble a symbol sequence corresponding to the symbol sequence from which the reads were initially generated. In FIG. 7, as in many subsequent illustrations, only a single symbol sequence is shown being assembled from constituent reads. As discussed above, a genome can be represented as two complementary, anti-parallel sequences. When the described computational processes are carried out on reads produced from two complementary, anti-parallel sequences, the two complementary, anti-parallel sequences are assembled. Alternatively, the computational process may instead assemble only one of the two complementary, anti-parallel sequences, identifying and discarding those reads generated from the symbol sequence that is not assembled from reads by the computational process. There is no loss in generality from describing the computational methods as assembling both of the complementary, anti-parallel sequences or as assembling only one of the complementary, anti-parallel sequences.

In FIG. 7, 13 reads 702-714 are shown in a column 716. Computational reconstruction of the initial symbol sequence from which the reads were produced generally involves overlapping reads to produce the initial symbol sequence. In FIG. 7, the initial symbol sequence 718 is shown vertically oriented, and the positions of the reads with respect to the initial symbol sequence are indicated by dashed lines and curved brackets, such as dashed line 720 and curved bracket 722, which indicate the position of read 702 with respect to the initial symbol sequence 718. By assembling the reads in the overlapping positions, as shown in FIG. 7, the initial symbol sequence is recovered. However, the problem of assembling reads to produce a corresponding initial symbol sequence is non-trivial, particularly in actual computational processing of tens to hundreds of millions of reads produced from a genome-sequencing procedure.

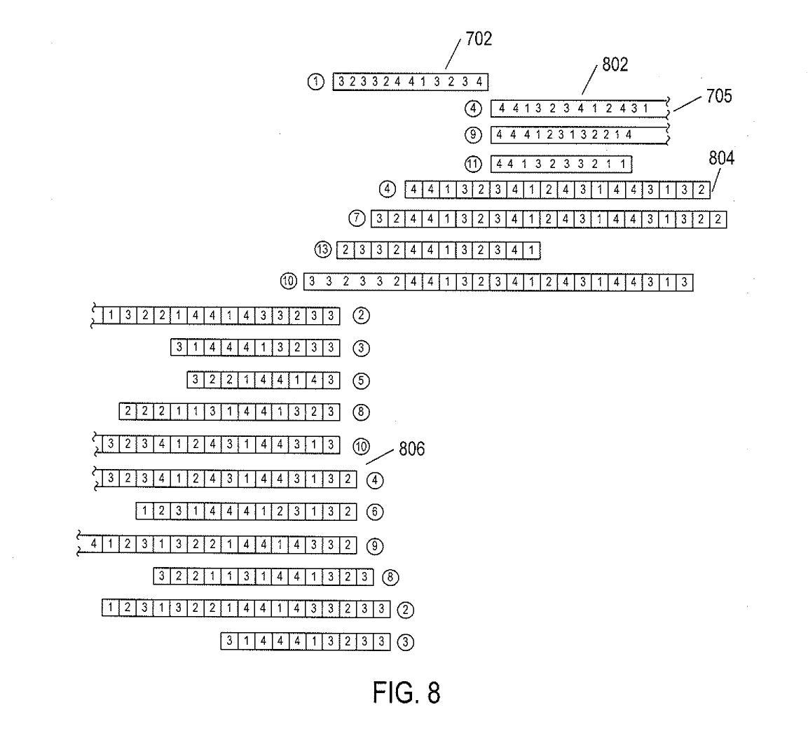

FIGS. 8-11B illustrate one computational method for assembling reads to produce an initial symbol sequence from which the reads were generated. In FIG. 8, the first read 702 is selected from the column of reads 716 shown in FIG. 7, and the remaining reads of the column are then aligned with the selected read 702 to generate all possible overlappings of the remaining reads with the selected read. For example, the first symbol of the fourth read 705 can be aligned 802 with the last symbol of the first read 702, can be aligned 804 so that the first seven symbols of the fourth read overlap and align with the last seven symbols of the selected read, and can be aligned 806 so that the last 2 symbols of the fourth read overlap with the first two symbols of the selected read. Note that the symbol sequences are considered to have an ordering, or polarity. For example, the sequence “323324413234” is different from the reversed sequence “432314423323.”

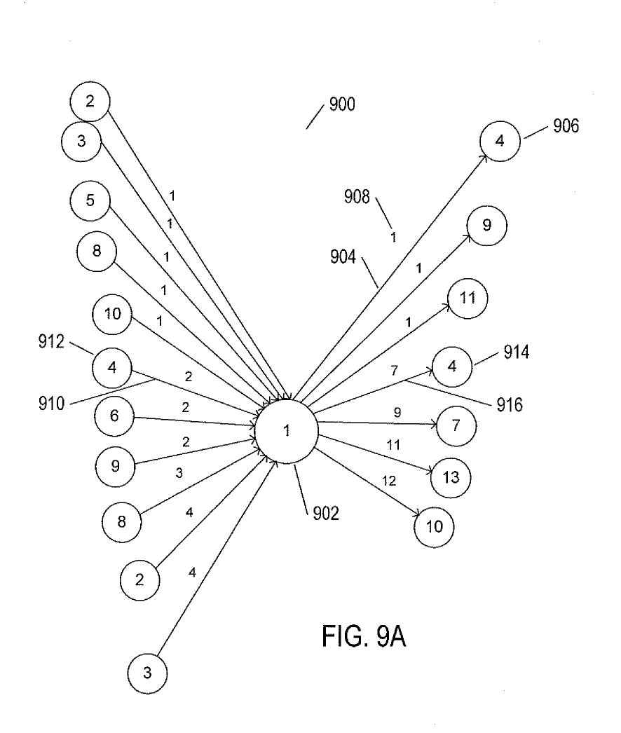

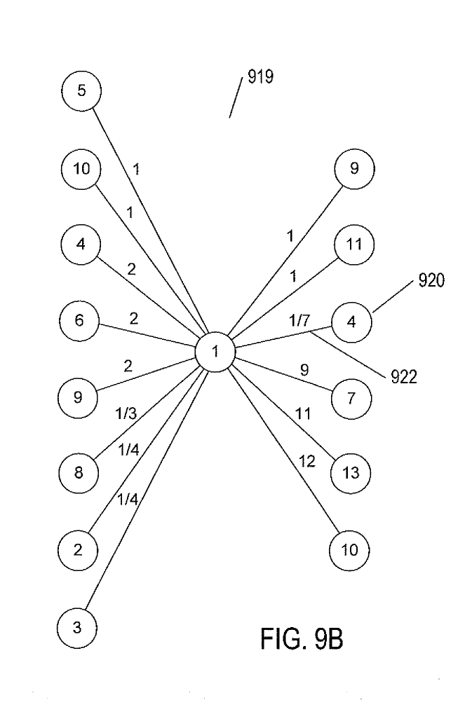

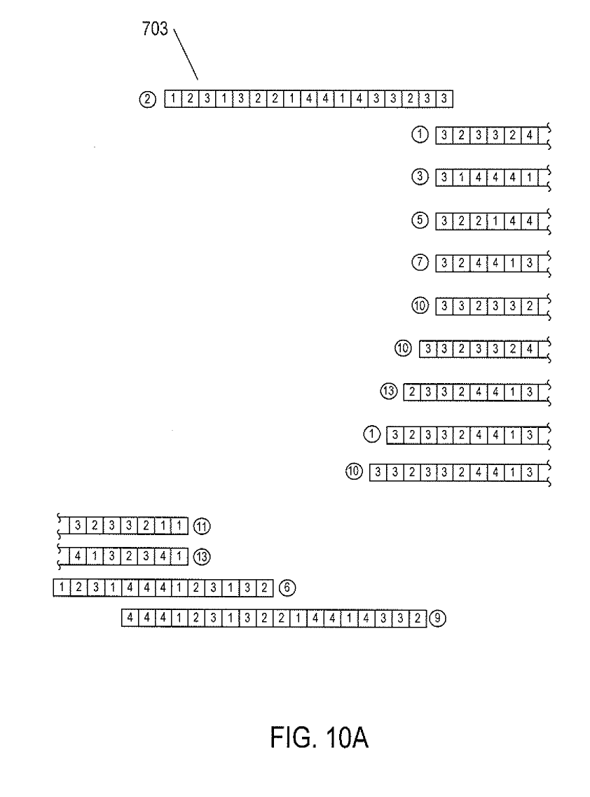

The overlapping constructed in FIG. 8 can be represented by a graph, FIG. 9A illustrates a first graphical representation of the overlapping of reads constructed in FIG. 8. The selected first read is represented by a central node 902 in the graph 900. Those overlappings in which latter symbols of the selected first sequence overlap initial symbols of an overlapped sequence are shown by directed arrows leading from the node 902 representing the selected sequence to nodes representing the overlapped sequence, such as directed arrow 904 indicating the first selected sequence, represented by node 902, overlaps the fourth read, represented by node 906, from the left. A numerical weight is associated with each directed arrow, or directed edge, indicating the number of symbols by which the nodes connected by the directed edge overlap. For example, the first read overlaps the fourth read from the left by one symbol, as indicated by the weight “1” 908. The overlap represented by nodes 902 and 906 and directed edge 906 is alternatively shown in FIG. 8 by read 705 in position 802. When final symbols of a read overlap initial symbols of the selected read, as do the final two symbols of the fourth read 705 in position 806 with respect to the selected first read 702 in FIG. 8, then a directed edge connects a node representing the overlapping sequence and the selected sequence, such as directed edge 910 connecting node 912 to node 902, representing the overlap of the fourth read 705 with the selected read 702 in position 806, shown in FIG. 8. In FIG. 9A, a given read may be represented by multiple nodes to indicate multiple possible alignments of the read to a selected symbol sequence. For example, the fourth read 705 is represented by three nodes 906, 912, and 914 in FIG. 9A, representing alignment positions 802, 804, and 806 in FIG. 8. Multiple nodes connected to the node representing the selected read by directed edges of the same polarity can be replaced by a single node, as in graph 919 shown in FIG. 9B. In such cases, the weights of the combined directed edges are concatenated with “/” separators. For example, nodes 906 and 914 and directed edges 904 and 916 in graph 900, shown in FIG. 9A, are replaced, in graph 919 shown in FIG. 9B, by the single node 920 and the single directed edge 922.

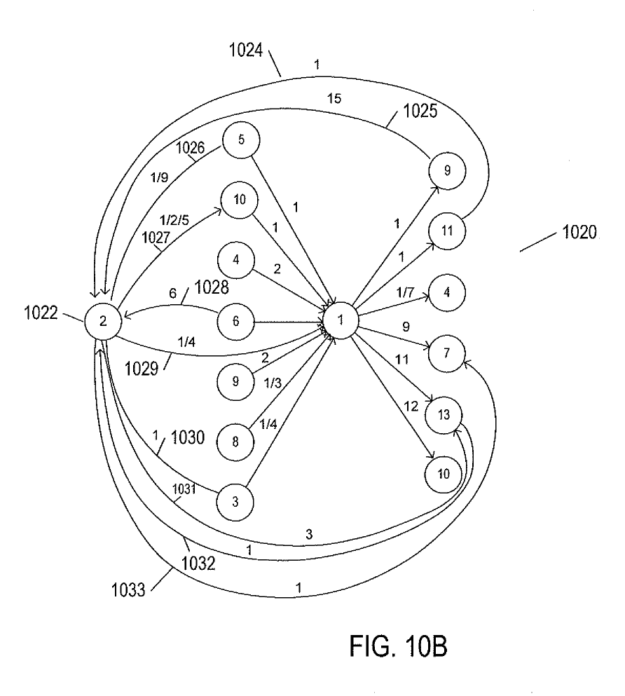

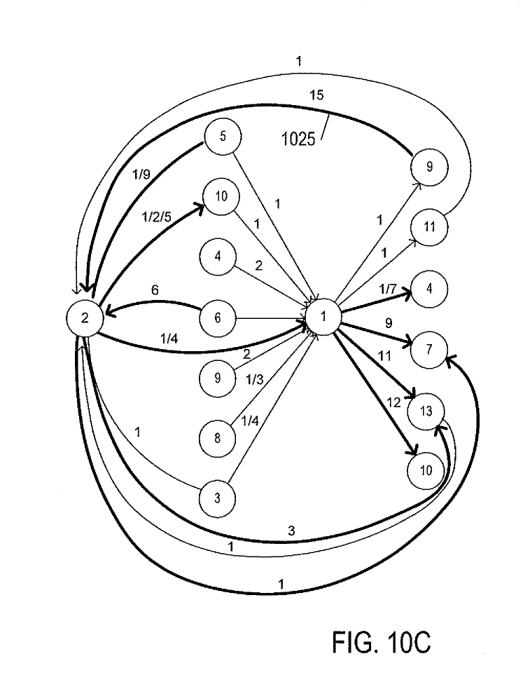

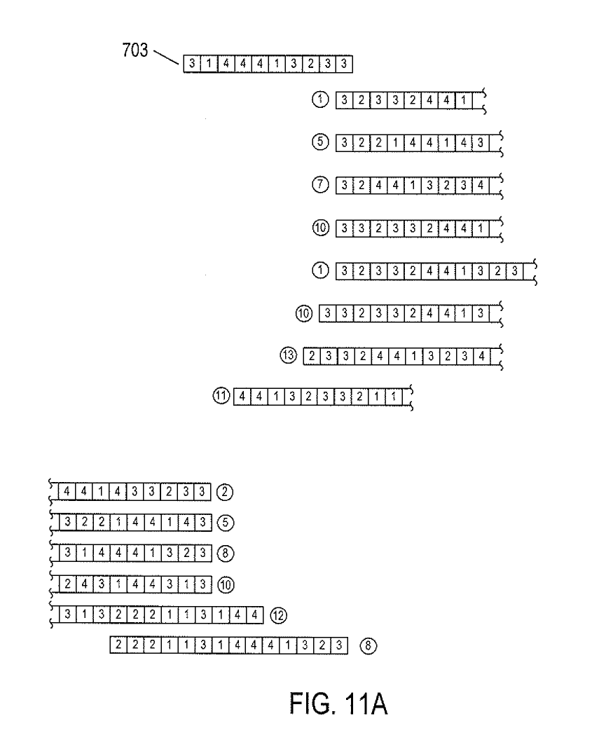

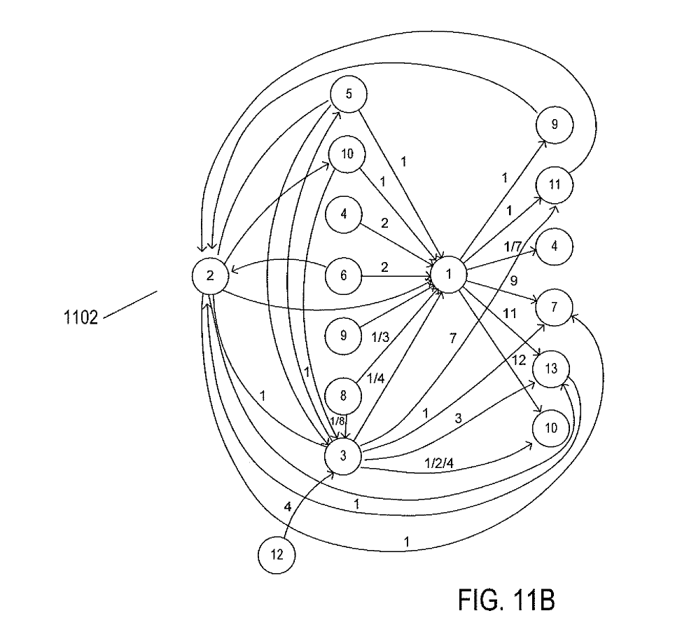

The graph shown in FIG. 9B is the beginning of a read overlap graph. A read overlap graph can be constructed by successively expanding nodes of an initial graph, such as that shown in FIG. 9B For example, as shown in FIG. 10A, the second read 703 is selected and the possible alignments of the remaining nodes with the second node are generated, as in FIG. 8 for the first read. These alignments can then be added to the initial graph to produce graph 1020 shown in FIG. 10B. Node 1022 represents the second read 703, with directed edges 1024-1033 representing the overlaps shown in FIG. 10A. Several characteristics of read-overlap graphs are revealed in graph 1020. First, a particular read does not necessarily overlap all other reads. The number of overlaps can be partially controlled by establishing a minimum overlap threshold. For example, were a minimum overlap threshold of 2 established for the example of FIGS. 7-10B, then 8 of the 23 directed edges in graph 1020 would be eliminated. In a practical computational procedure, generating and using a read overlap graph without establishing a minimum overlap threshold would be far too inefficient and unwieldy due to the combinatorial explosion of nodes and directed edges. Second, as illustrated in FIG. 10C, only a fraction of the directed edges represents actual overlaps of reads with the symbol sequence from which they were generated. In FIG. 10C, the directed edges corresponding to actual overlaps shown in FIG. 7 are bolded, such as directed edge 1025. Note that only one the directed edges associated with the minimal weight “1” represents an actual overlap, while 6 of the directed edges associated with the weight “1” are spurious. By establishing a minimum overlap threshold, many spurious edges are prevented from being introduced in a read overlap graph. A second expansion of the read-overlap graph is illustrated in FIGS. 11A-B, using the same illustration conventions used in FIGS. 8-10B. FIG. 11A shows overlaps with respect to the third read 703. In FIG. 11B, graph 1102 shows the read-overlap graph previously shown in FIG. 10B with the additional overlaps shown in FIG. 11A added to the graph. Clearly, even for the tiny example of FIGS. 7-11B, with only three nodes expanded, the read-overlap graph is becoming complicated. A read overlap graph for tens of millions of reads produced by a genome-sequencing procedure is computationally difficult to generate, encode, and store within a processor-controlled system by automated methods, and quite impossible to generate and used by anything other than processor-controlled systems.

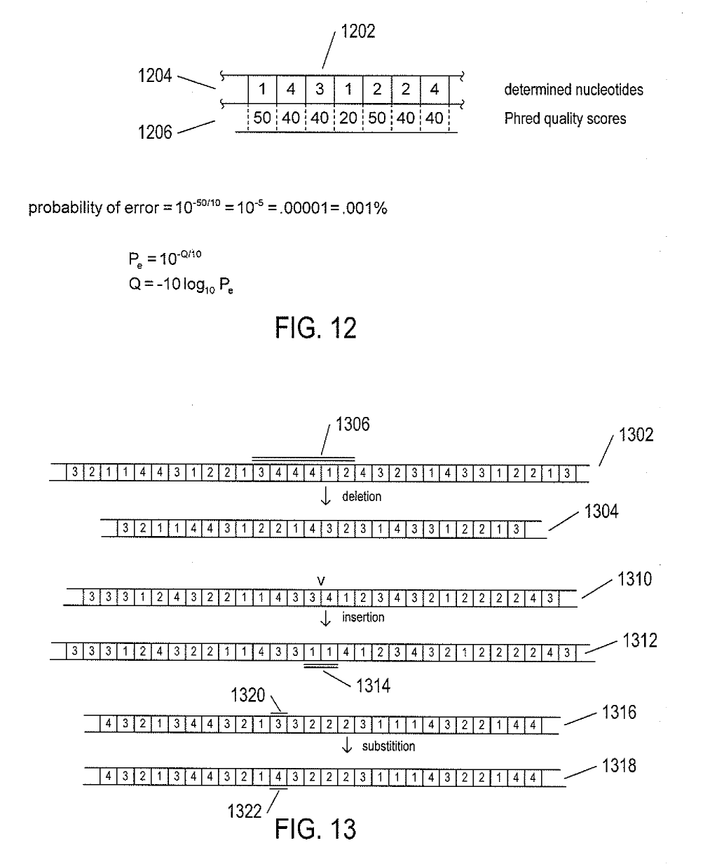

FIG. 12 illustrates quality scores often associated with symbols of a symbol sequence produced by chemical and/or instrumental sequencing methodologies. A small portion of a read sequence 1202 is shown at the top of FIG. 12. The symbols representing nucleotides are shown in a first horizontal row 1202 and quality scores for each symbol/nucleotide are shown in a second horizontal row 1206. In the example shown in FIG. 12, the quality scores are Phred quality scores. The relationship between the probability that a particular symbol in the read is erroneous, Pₑ, is related to the Phred score for the symbol, Q, by the relationships:

$${P}_{e} = {10}^{- \frac{Q}{10}}$$

$$Q = - 10 {log}_{10} {P}_{e}$$

Thus, the probability that a symbol associated with a Phred score of 50 is erroneous is 0.00001 or 0.001%, the probability that a symbol associated with a Phred score of 40 is erroneous is 0.0001 or 0.01%, the probability that a symbol associated with a Phred score of 30 is erroneous is 0.001 or 0.1%, the probability that a symbol associated with a Phred score of 20 is erroneous is 0.01 or 1%, and the probability that a symbol associated with a Phred score of 10 is erroneous is 0.1 or 10%. Phred scores are automatically generated by certain types of sequencing instruments. An erroneous symbol is an incorrect assignment of a monomer to a particular symbol. In other words, in a case that the true monomer at a position of a genome is associated with the symbol “3,” and a genome-sequencing procedure reports a symbol “2” for that position, the symbol “2” is erroneous.

FIG. 13 illustrates certain of various types of genetic variants that are observed in organisms, including humans. In each illustration of a variant, a first, reference symbol sequence that represents a normal genome sequence is first shown, such as reference symbol sequence 1302. Then, a second symbol sequence that illustrates the variant is shown, below the reference symbol sequence, such as variant symbol sequence 1304. The first type of variant is referred to as a “deletion.” A deletion is a deletion of a subsequence of one or more symbols from the reference symbol sequence, In FIG. 13, a subsequence 1306 of the reference symbol sequence 1302, indicated by double horizontal lines, is removed, or deleted, to generate the variant symbol sequence 1304. Reference symbol sequence 1310 and variant symbol sequence 1312 illustrate an insertion, where the two-symbol subsequence “11” 1314 is added to the reference symbol sequence to create the variant symbol sequence 1312. Reference symbol sequence 1316 and variant symbol sequence 1318 illustrate a substitution. Symbol “3” 1320 in the reference symbol sequence is changed to symbol “4” in the variant symbol sequence. Various hybrid variations may also be observed, including substitution of a longer or shorter subsequence for a reference subsequence to produce both a substitution and insertion or deletion. Symbol subsequences may be inverted, and portions of one chromosome added to portions of another chromosome, referred to as a translocation. In certain implementations of the automated methods and processor-controlled system to which the current document is directed, a goal is to assemble reads produced by a genome-sequencing procedure in order to detect variations in the symbol sequence from which the reads were generated with respect to a reference symbol sequence. Insertions, deletions, and substitutions can range from a single symbol to tens, hundreds, thousands, or more symbols.

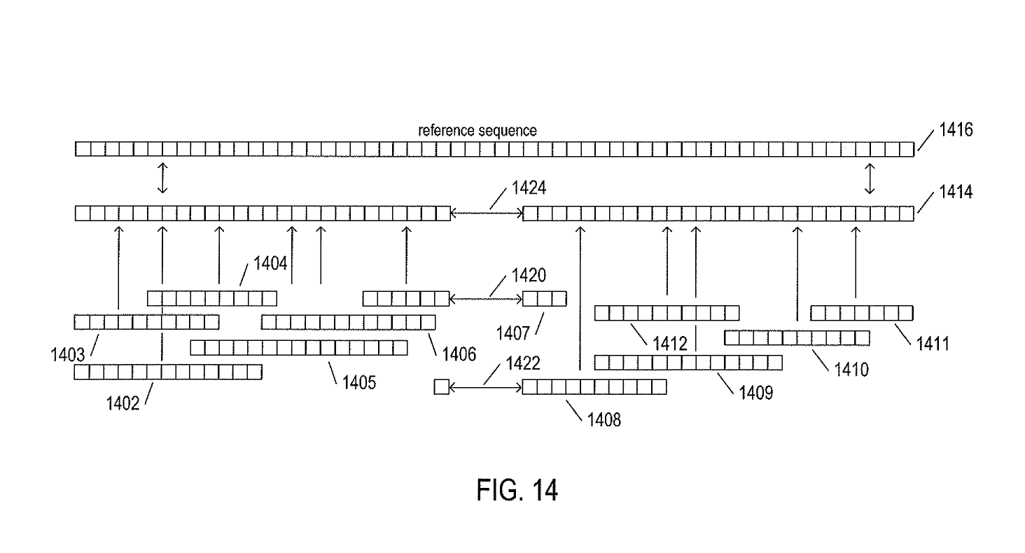

FIG. 14 illustrates detection of a deletion by read assembly. In FIG. 14, a number of reads 1403-1412 are assembled, by overlap analysis, to generate a variant symbol sequence 1414 which is aligned to a reference symbol sequence 1416. Reads 1408 and 1407 and assembled variant symbol sequence 1414 include double-headed arrows 1420, 1422, and 1424 that indicate the position of a deletion that is detected when the variant symbol sequence 1414 is aligned to the reference sequence. In other words, the deleted subsequence is not observed in the reads and the assembled variant symbol sequence, but discovered during alignment of the variant symbol sequence 1414 with the reference symbol sequence 1416. It is the detection of variants, at various positions within a sequenced genome with respect to a reference genome, that the automated methods and processor-controlled systems to which the current document is directed find particular utility.

### Detailed Description of the Automated Methods and Processor-Controlled Systems to which the Current Document is Directed

As discussed above, reads from a genome-sequencing procedure can be computationally assembled into an overlapping structure, as shown in FIG. 7, to generate a symbol sequence that represents the genome sequence from which the reads are generated. However, as also discussed above, read-overlap graphs that describe all possible of mutual alignments between reads may be very computationally complex to generate, process, encode, and store. When there are errors in the reads, large subsequences comprising contiguous repeats of short repeated sequences, and uneven coverage of the initial sequence by the reads, the computational task is even more daunting. The automated methods and processor-controlled systems to which the current document is directed employ various methods and procedures to simplify computational read assembly.

One method involves k-merization of reads followed by filtering of the k-mers generated by k-merization, and then use of the filtered k-mers to correct the reads from which the k-mers were generated. Corrected reads facilitate overlap-graph-based read assembly that is employed to detect variations in a genome with respect to a reference genome.

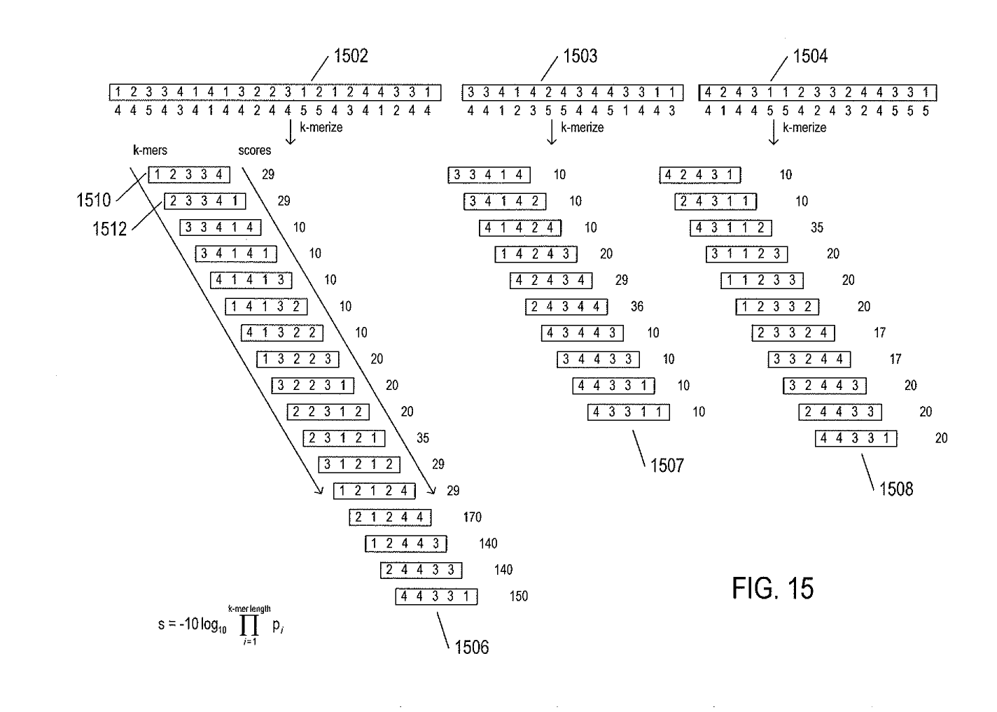

FIG. 15 illustrates k-merization of reads. In FIG. 15, three example reads 1502-1504 are shown at the top of the figure. Diagonal columns of k-mers 1506-1508 are shown below each read. The k-mers, in this example, represent every possible 5-symbol subsequence of the corresponding read. The first k-mer 1510 of read 1502 includes the first five symbols of the read “12334.” The second k-mer 1512 includes symbols 2-6 of the read 1502. Each successive k-mer begins at a next, successive position within the read.

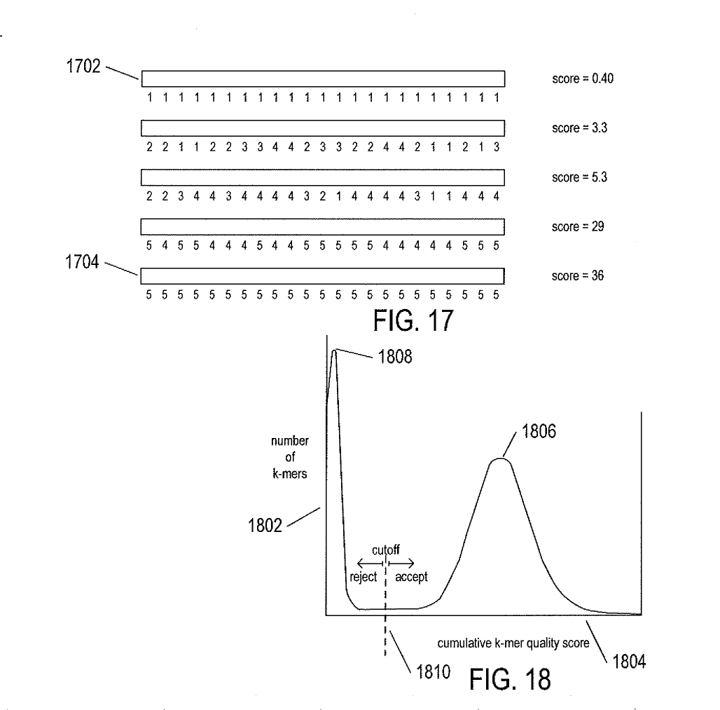

As also shown in FIG. 15, each k-mer is associated with a score. The score is computed from the Phred scores associated with the symbols of the read corresponding to the symbols of a k-mer. For example, the Phred scores for the first 5 symbols of the first read 1502 are 40, 40, 50, 40, and 30. Note that the Phred scores shown in FIG. 15 are truncated to the most significant digit, with Pfred score “50,” for example, truncated to “5.”. This convention is employed in subsequent figures, including in FIG. 17. The k-mer score is computed as:

$$k \text{-} mer score S = - 10 {log}_{10} {\prod }_{i = 1}^{k} {P}_{i}$$

where k is the k-mer length; and

Pᵢ is the probability that the i^{th} symbol of the k-mer is correct.

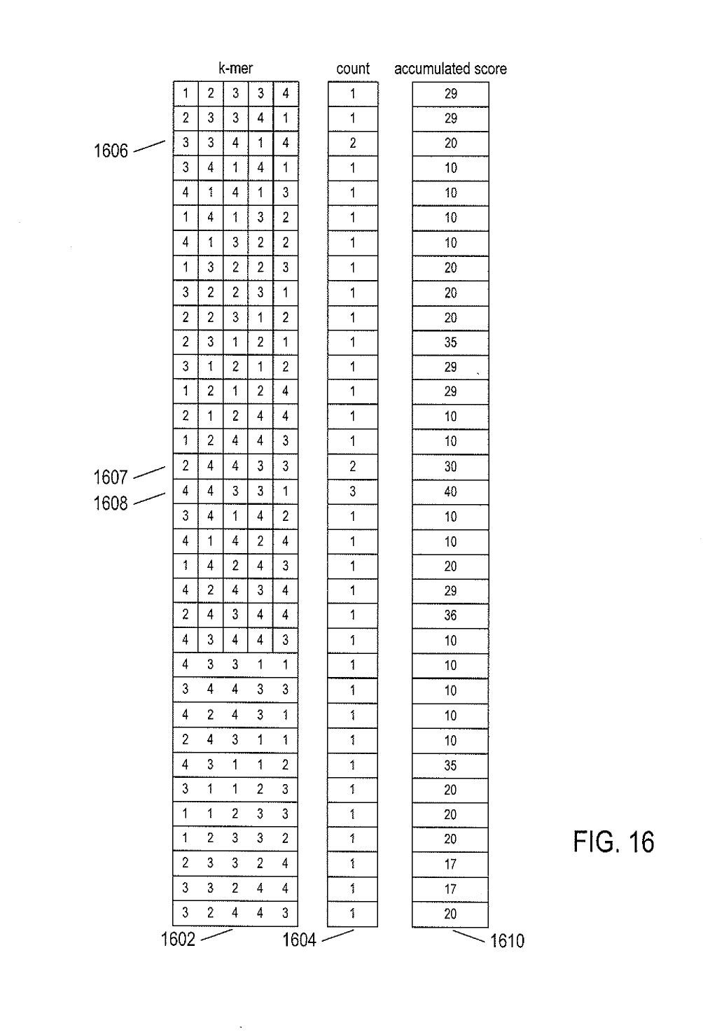

The k-mers generated from a set of reads are next tabulated. FIG. 16 shows a table of the unique k-mers generated by k-merization of reads 1502-1504, shown in FIG. 15. A first column 1602 lists each unique k-mer. A second column 1604 indicates the number of each unique k-mer observed in the k-mers generated from the three reads. There are multiple copies observed for three k-mers 1606-1608. In a third column 1610, cumulative scores are shown for each unique k-mer. The cumulative k-mer score is the sum of the k-mer scores computed for the instances of the k-mer observed in the k-merization. Thus, the cumulative k-mer score for a k-mer depends both on the Phred scores, or other quality scores, associated with the symbols in each k-mer as well as on the number of copies of the k-mer observed in the k-merization. The cumulative k-mer score thus reflects the number of k-mers observed as well as their individual quality scores.

FIG. 17 illustrates the range of k-mer scores that can be observed for 23-symbol k-mers. In human genome sequencing, k-mers of length 23 are often chosen, as k-mers of length 23 have a reasonably good probability of being unique. When all symbols of the k-mer are associated with the very poor Phred score “10,” as shown in the first example k-mer 1702, the k-mer score is 0.4. When all symbols of the k-mer are associated with the very good Phred score “50,” as shown in the final example k-mer 1704, the k-mer score is 36. K-mer scores thus range from 0.4 to 36 for k-mers of length 23.

As discussed above, common genome-sequencing procedures produce reads from a large number of genome-sequence copies. The number of copies, referred to as the “coverage depth,” may range from 20 to 60 or more. Thus, many levels of overlapping reads are expected to be produced. When these reads are k-merized, each legitimate k-mer would be expected to be observed at some multiple of the coverage depth. However, k-mers generated from erroneous reads that contain erroneous symbols would be expected to be observed at much lower levels, since the probability of errors is relatively small, and each particular erroneous symbol-substitution error has a probability of about ⅓ of the already small error probability. Furthermore, the Phred scores associated with erroneous symbols are generally lower than those associated with correct symbols. As a result, erroneous k-mers are expected to have much lower cumulative scores than legitimate k-mers.

FIG. 18 shows a generalized distribution of k-mer scores observed for actual genome-sequencing procedures. In FIG. 18, the number of unique-k-mers, plotted with respect to vertical axis 1802, associated with each cumulative k-mer quality score, plotted with respect to the horizontal axis 1804, form a bimodal distribution with a large, broad peak 1806 of k-mers with relatively large cumulative scores and a narrow peak 1808. The broad peak represents legitimate k-mers, each observed a sufficient number of times in a set of reads to have a relatively high probability of not containing errors. The narrow peak represents k-mers that have a high probability of having erroneous symbol sequences, since their low cumulative scores reflect low frequency of observation in a set of reads as well as relatively low cumulative scores indicating a relatively high probability that they include erroneous symbols.

Of course, when k-mers generated from a set of reads include symbol errors, the reads from which the erroneous k-mers were generated also contain symbol errors. Symbol errors in reads greatly frustrate the process of using read-overlap graphs to assemble the symbol sequence from which the reads were generated. Reads containing erroneous symbols contribute to a combinatoric explosion in the numbers of nodes and directed edges of a read-overlap graph. In order to use read-overlap graphs and other assembly tools, erroneous symbols within reads of a set of reads need to be corrected.

In order to correct the reads, a threshold cumulative score, or cutoff cumulative k-mer quality score 1810 is determined to separate the legitimate k-mers, represented by the broad peak 1806 in the bimodal quality-score distribution, from the likely erroneous k-mers, represented by the narrow peak 1808 in the bimodal quality-score distribution. Those k-mers with cumulative quality scores below the threshold or cutoff cumulative k-mer quality score are rejected, and the cumulative quality scores above the threshold or cutoff cumulative k-mer quality score are used to correct the reads of a set of reads. The legitimate k-mers are used to construct a De Bruijn graph, and the De Bruijn graph is used to identify and correct erroneous symbols within reads. The ability to identify legitimate k-mers is, as discussed, a product of the redundancy in symbol sequences from which reads are produced.

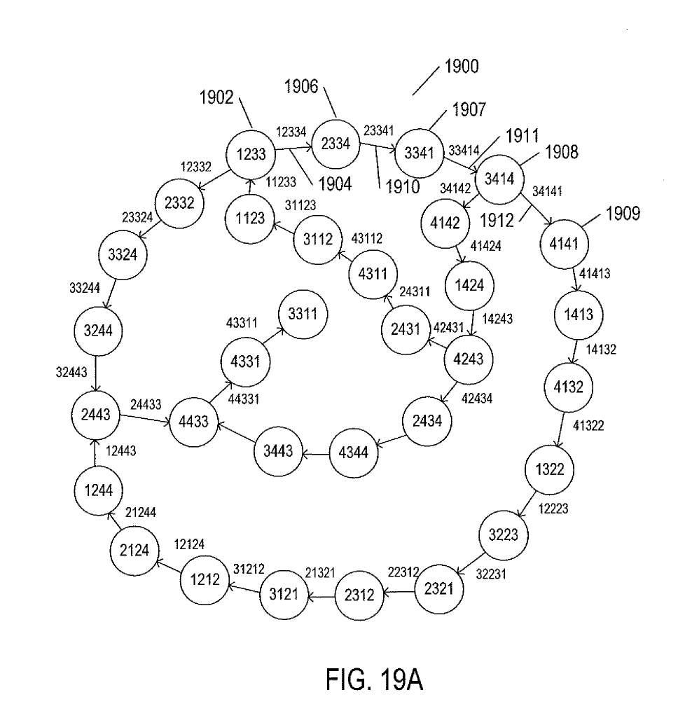

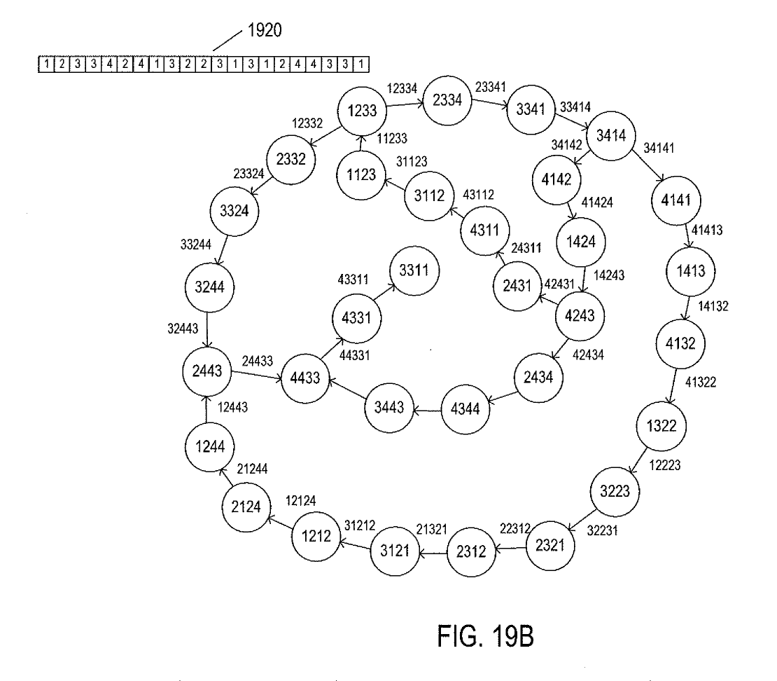

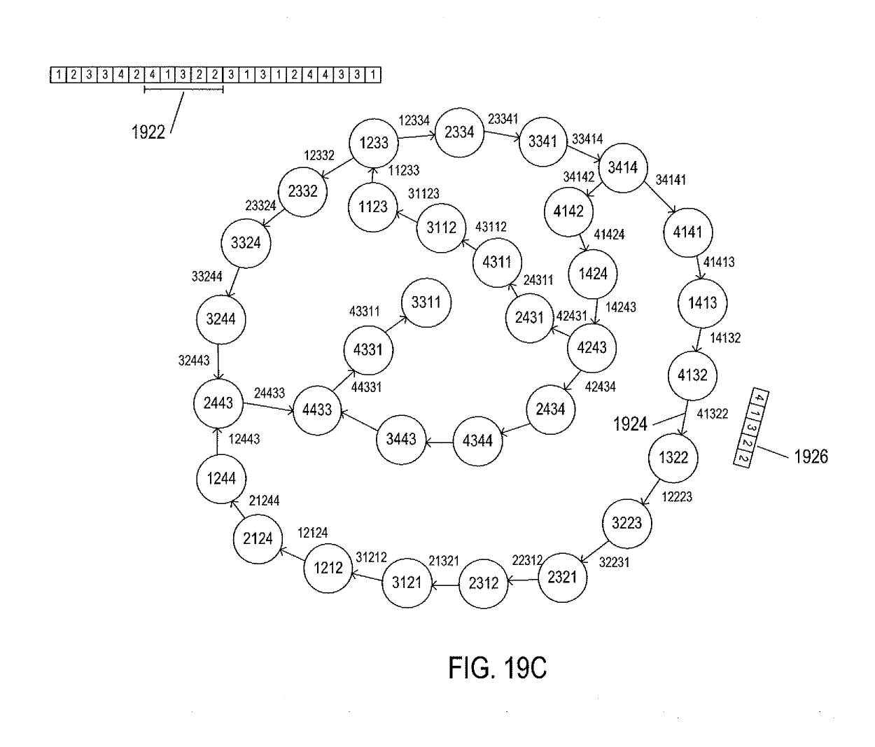

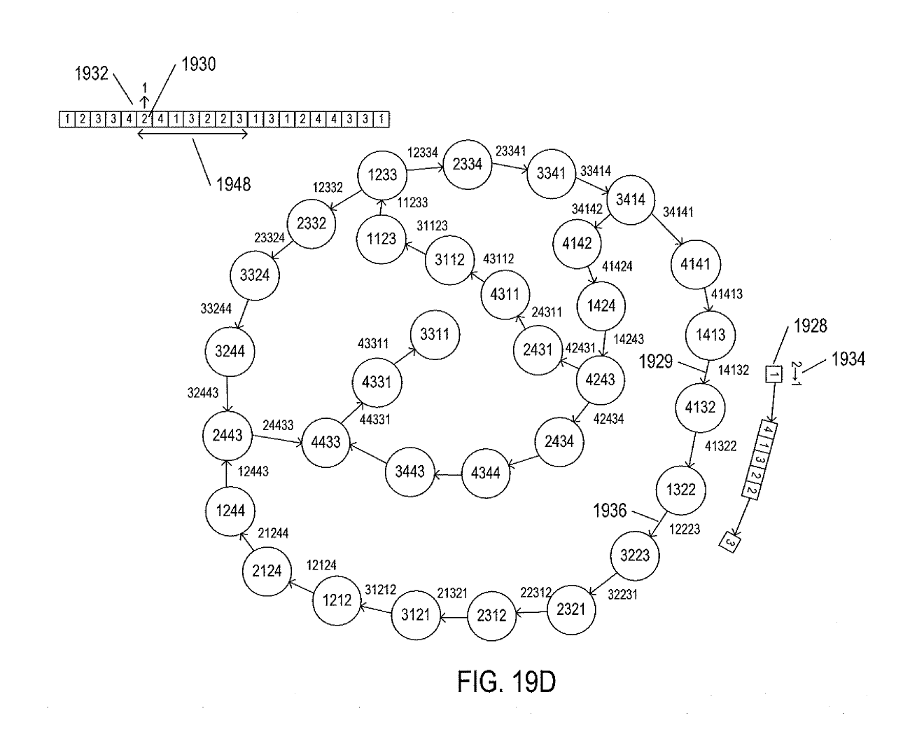

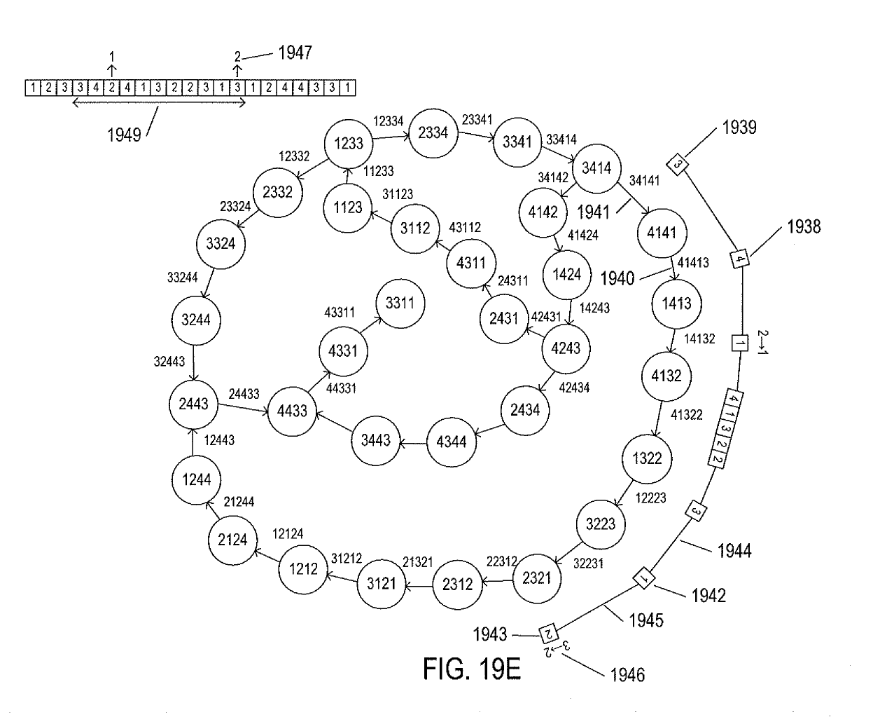

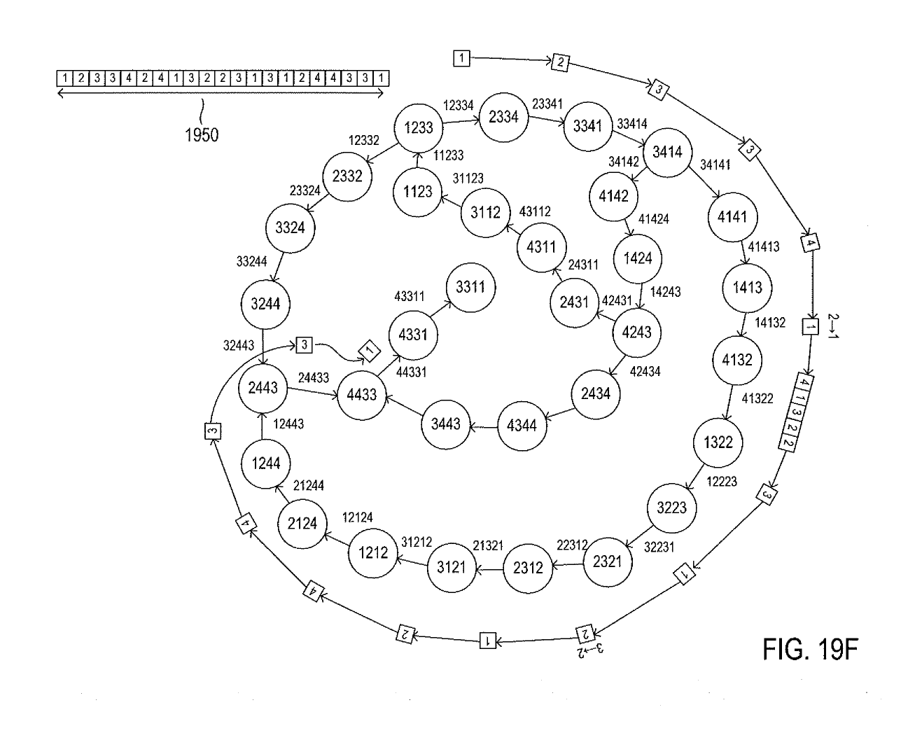

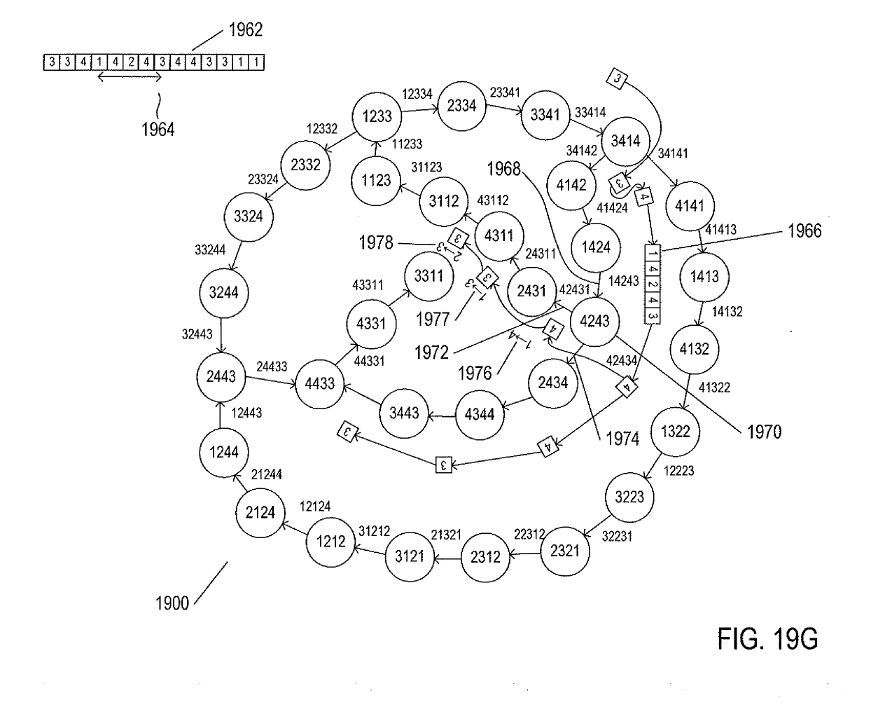

FIG. 19A-G illustrate a De Bruijn graph and threading of a read into a De Bruijn graph. FIG. 19A shows a De Bruijn graph 1900 generated from the unique k-mers, listed in FIG. 16, generated from the read 1502-1504 shown in FIG. 15. The nodes of the graph, such as node 1902, are k-mers of length k−1. In FIG. 16, the k-mers have length 5, so the nodes of the De Bruijn graph 1900 represent k-mers of length 4. The directed edges of the De Bruijn graph, such as edge 1904, represent the k-mers of length k. Each k-mer of length k is generated from a first k-mer of length k−1 connected by a directed edge to a second k-mer of length k−1 and the second k-mer of length k−1 by overlapping the first k-mer and the second k-mer across k−2 positions. For example, k-mer of length k “12334,” represented by directed edge 1904, is produced by overlapping k-mer of length k−1 “1233,” represented by node 1902, and k-mer of length k−1 “2334,” represented by node 1906. The second symbol of the first k-mer of length k−1 overlaps the first symbol of second k-mer of length k−1:

$$\begin{matrix}1233 \\ 2334\end{matrix}$$

Assuming that the De Bruijn graph includes all legitimate k-mers from a set of reads generated from multiple copies of an initial symbol sequence, then all of the reads can be generated by traversing nodes of the De Bruijn graph through directed edges and generating a consensus sequence from all of the k-mers of length k represented by the traversed directed edges. For example, traversing De Bruin Graph 1900 from node 1902 to node 1909 along edges 1904 and 1910-1912 through nodes 1906-1908 generates the consensus sequence “12334141.” The consensus is generated by the k-mers of length k−1 included in the traversed nodes as follows:

$$\frac{\begin{matrix}1233 \\ 2334 \\ 3341 \\ 3414 \\ 4141\end{matrix}}{12334141}$$

The consensus is generated by the k-mers of length k corresponding to the traversed directed edges as follows:

$$\frac{\begin{matrix}12334 \\ 23341 \\ 33414 \\ 34141\end{matrix}}{12334141}$$

However, when only legitimate k-mers are used to construct the De Bruijn graph, and the reads include symbol errors, then a read containing a symbol error cannot be exactly generated by a De Bruijn graph traversal. Instead, the symbol errors need to be corrected in order to superimpose the read onto the De Bruijn graph. Superposition of a read onto a De Bruijn graph is referred to as threading the read onto the De Bruijn graph. In many cases, there may be multiple ways to thread a read onto a De Bruijn graph, each threading corresponding to a possible reconstruction of the read from unique k-mers included as directed edges in the De Bruijn graph. In general, when all possible threadings of a read onto a De Bruijn graph involve symbol substitutions within the read, then the most likely threading is chosen as the correct threading, and the symbol substitutions needed for the correct threading represent corrections of erroneous symbols. The most likely threading is the threading for which the cumulative symbol-substitution score for the substitutions is lowest, according to the methods and systems to which the current document is directed.

FIGS. 9B-G illustrate the threading of a read into De Bruijn graph 1900 shown in FIG. 19A. The read to be threaded 1920 is shown at the top left of FIG. 19B. In a first step, shown in FIG. 19C, a k-mer of length k is selected from the set of k-mers represented by the directed edges of the De Bruijn graph. The selected k-mer 1926 corresponds to directed edge 1924. The selected k-mer 1922 is shown positioned near the directed edge 1924 in FIG. 19C. Next, as shown in FIG. 19D, the initial, selected k-mer 1926 is extended along directed edges. A leftward extension 1928 and directed edge 1929 is only possible by changing the symbol “2” 1930 in the read to “1,” as indicated by arrow-based notations 1932 and 1934. The rightward extension proceeds along directed edge 1936 without the need to change the corresponding symbol “3” in the read. Now, the subsequence “1413223” has been successfully thread onto the De Bruijn graph, at the cost of on symbol substitution 1932 and 1934. FIG. 19E illustrates two additional extensions in both the leftward and rightward directions, including leftward extensions 1938-1939 along directed edges 1940-1941 and rightward extensions 1942-1943 along directed edges 1942-1943. Rightward extension 1943 involves a second symbol substitution 1944 and 1946. In FIGS. 19D-F, the double headed arrows 1948-1950 indicate the progression of the extension of the read. FIG. 19F shows a full threading of read 1920 into the De Bruijn graph.

FIG. 19G shows a portion of a threading of a different read 1962 onto De Bruijn graph 1900. The initial k-mer “14243” 1964 is positioned 1966 next to matching directed edge 1968 and extended leftward and rightward. At node 1970, the traversal can proceed along two different directed edges 1972 and 1974. Thus, node 1970 is a branch point. When the threading proceeds along edge 1972, three symbol substitutions 1976-1978 are needed. However, when the threading proceeds along edge 1974, no additional symbol substitutions are needed. Thus, the cumulative substitution score for the traversal along directed edge 1972 is much larger than the cumulative score of 0 for the traversal along the edge 1974. In actual read-overlap graphs, there may be many branch points and therefore a large number of different possible read-overlap-graph threadings for any given read.

The cumulative symbol-substitution score is computed as the sum of the quality scores, such as Phred scores, for the symbols of the read that are changed to produce the threading. A cumulative symbol-substitution score for symbol substitutions is 0 when no substitutions are needed, and increases with increasing numbers of substitutions and with increasing probabilities that the substituted symbols were correct.

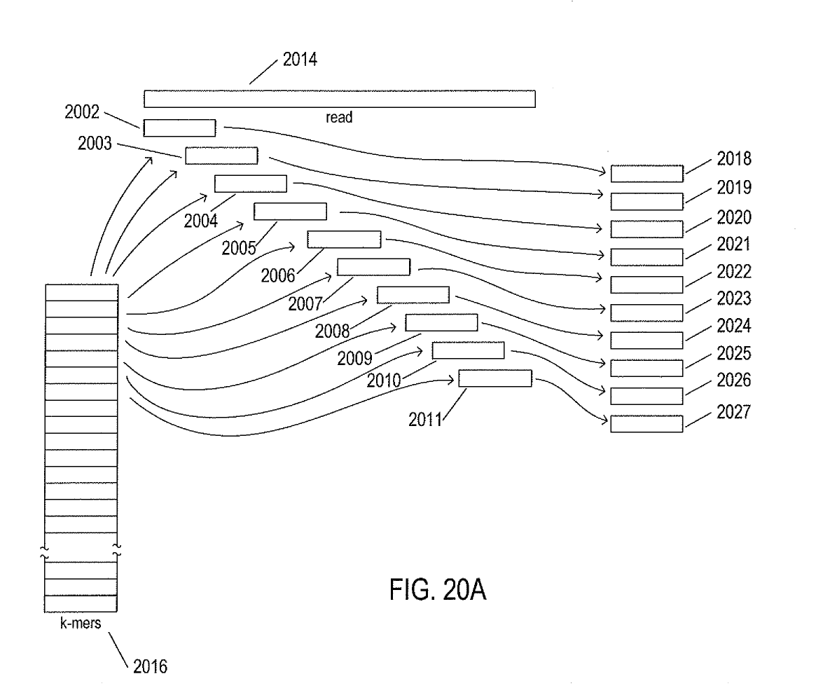

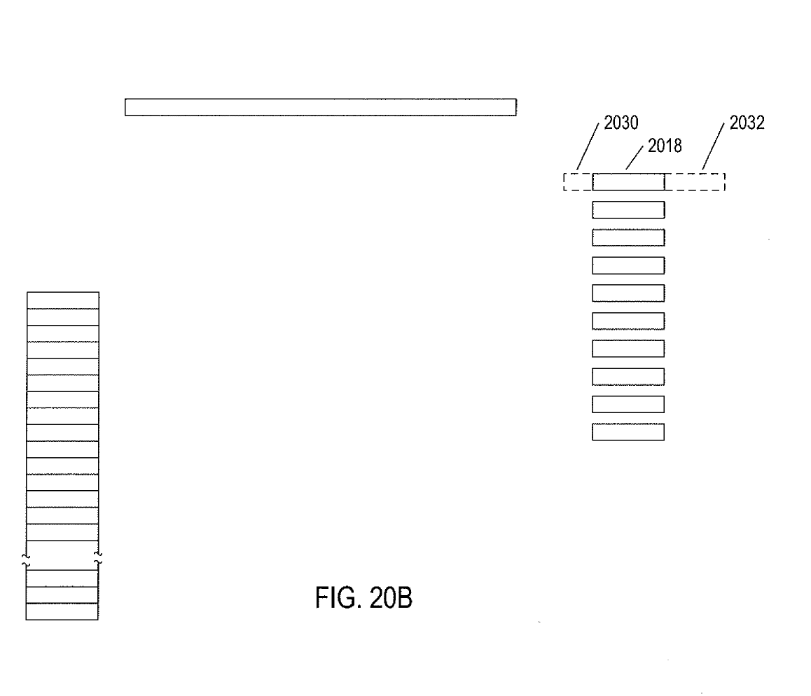

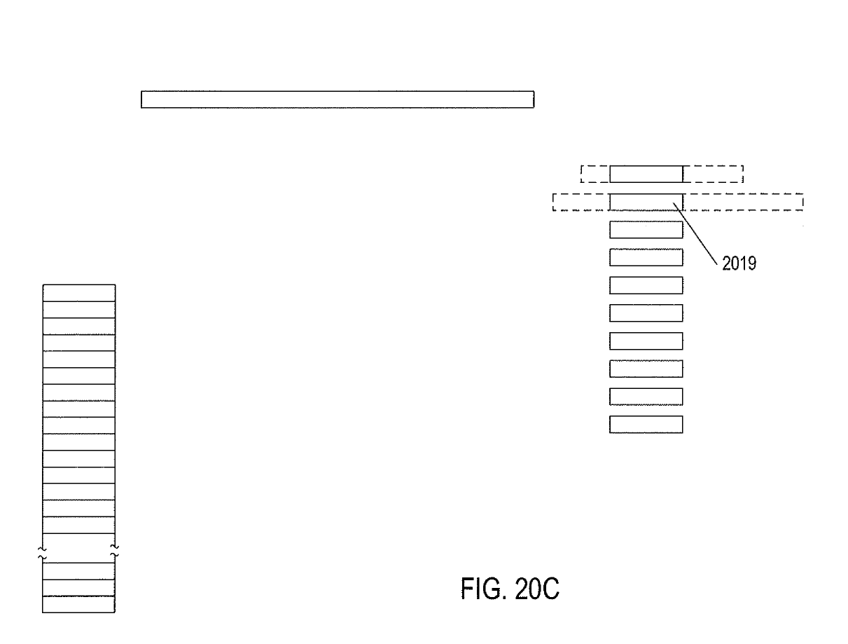

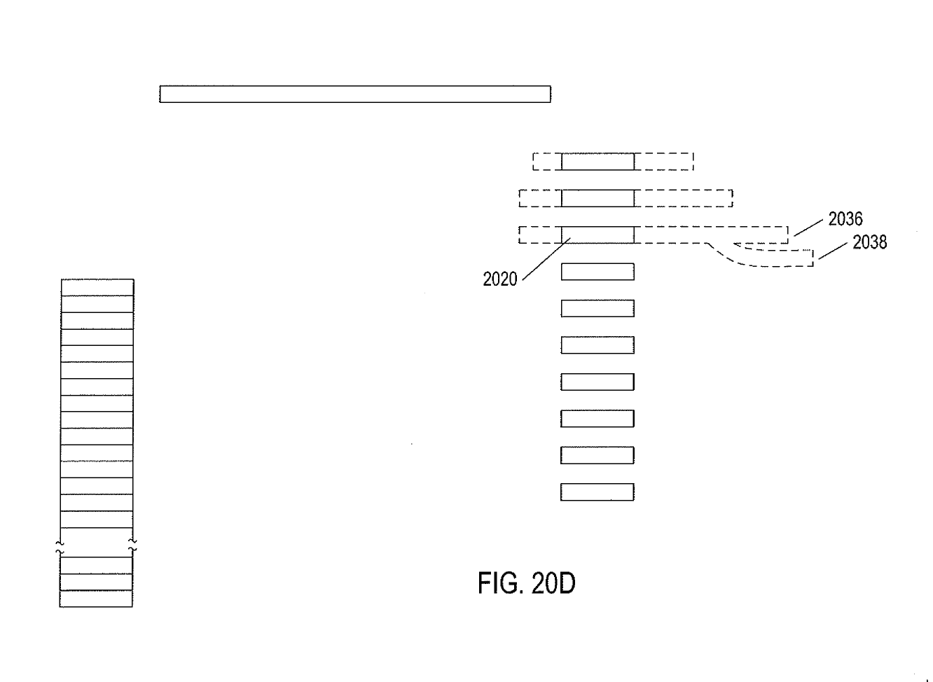

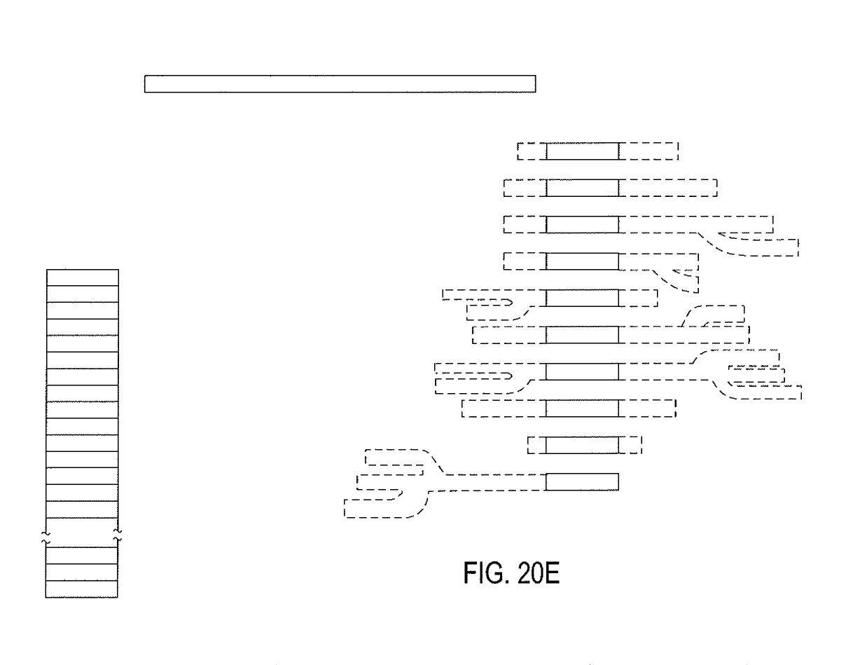

In order to correct read, the currently discussed automated methods and processor-controlled systems use a parallel approach to finding possible threadings onto a De Bruijn graph for each read, and then use the threading with the lowest cumulative symbol-substitution score for symbol substitutions to correct the read. When the lowest cumulative symbol-substitution score for symbol substitutions for a read is 0, then no corrections are needed. FIGS. 20A-E illustrate the parallel threading process for read correction. First, as shown in FIG. 20A, all legitimate k-mers 2002-2011 that exactly match subsequences in a read 2014 are selected from a set of legitimate k-mers 2016 produced by k-merization of a set of reads and cumulative k-mer-quality-score-distribution filtering, as discussed above with reference to FIGS. 15-18. These selected exactly matching k-mers are used as seeds 2018-2027 for threadings onto a De Bruin graph constructed from legitimate k-mers. In certain cases, the selected exactly matching k-mers may be filtered to remove redundant k-mers, such as k-mers that are directly connected by a directed edge in the De Bruijn Graph.

Next, as shown in FIG. 20B, the first seed 2018 is extended until a symbol substitution is needed. In FIG. 20B, the extensions 2030 and 2032 are shown in both directions. The directions for each next extension may be randomly or systematically selected. Then, as shown in FIG. 20C, a next seed 2019 is extended until two symbol substitutions are needed. As shown in FIG. 20D, a third seed 2020 is extended until three symbol substitutions are needed. In this case, a branch point was encountered, leading to two different extension paths 2036 and 2038. As discussed further, below, in certain implementations, new parallel processing threads are instantiated at branch points so that each possible threading is associated with a parallel processing thread. As shown in FIG. 20E, the process continues, with each next seed extended after extension of the previous seed was stopped due to the need for a greater number of symbol substitutions than previously encountered for other already extended seeds. When a seed is fully extended, it is a candidate for the threading with the least cumulative symbol substitution score. Once the cumulative symbol-substitution score for the threading carried out by a processing thread rises about the cumulative symbol-substitution score for the first fully extended seed, the processing thread may be terminated. Of course, were the first seed to be fully extended without symbol substitutions, then an exact matching threading would be obtained, and no additional threadings would be needed. Thus, the parallel threading process for read correction efficiently extends multiple seeds, in parallel, in order to efficiently identify an exact threading, if extension of one of the seeds leads to an exact threading. Threadings are extended only until the number of symbol substitutions or the cumulative symbol-substitution score exceeds that of any of the other threadings.

Once the reads of a set of reads have been corrected by the parallel threading process for read correction, described above with reference to FIGS. 15-20E, the reads are filtered to remove any reads that exactly align to a reference symbol sequence, in certain implementations of the automated methods and processor-controlled system to which the current document is directed. Exactly matching reads do not provide any information with regard to variant subsequences. Were the exactly matching reads included in the analysis, the read-overlap graph, in an actual variant-discovery process carried out on a genome-wide basis, would have millions of nodes and edges that provide no useful information. To simply the read-overlap graph and analysis, the analysis is focused onto variant subsequences by filtering out exactly matching reads. As a tiny example, the deletion detected by read assembly in FIG. 14 is present only in reads 1407 and 1408. The remaining reads exactly match the reference sequence. In an actual variant-determination process, reads are considerably longer than the small reads used to illustrate read assembly in FIG. 14, and it is therefore possible to find reads that partially align to the reference sequence but that also include non-matching symbols that are indications of variants. The read-overlap graph generated from those reads that do not exactly match subsequences within a reference sequence is generally disjointed, with separate clusters of reads connected by edges corresponding to each subsequence variation of the symbol sequence from which the reads were generated with respect to a reference sequence.

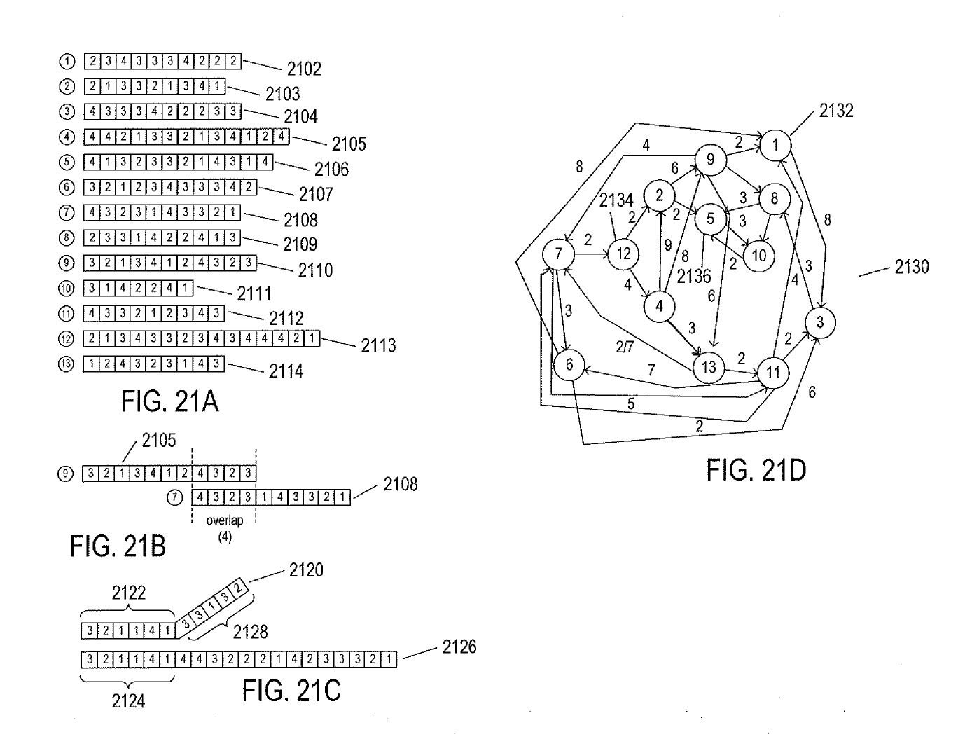

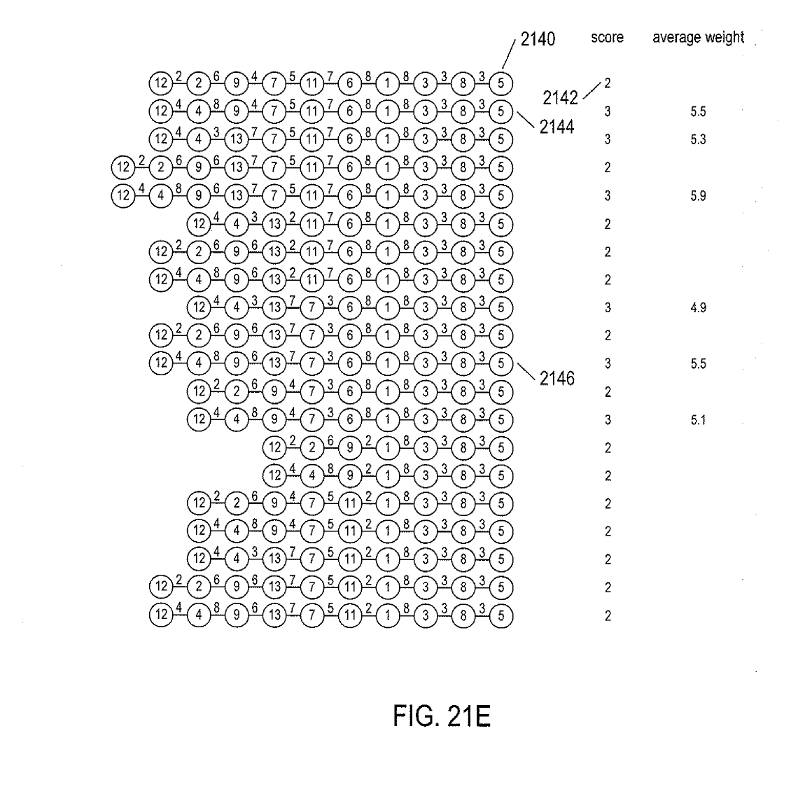

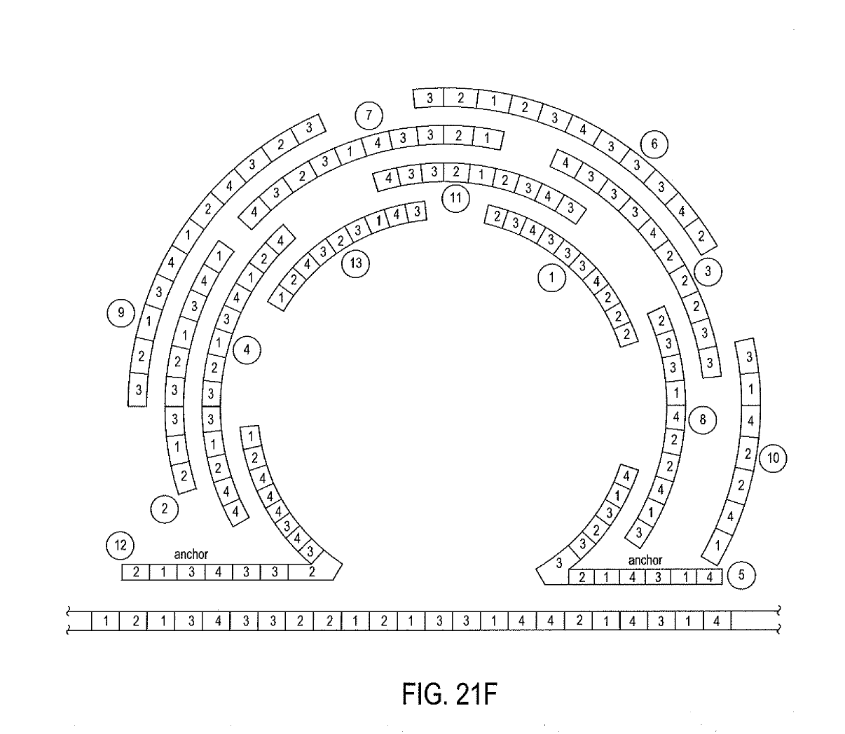

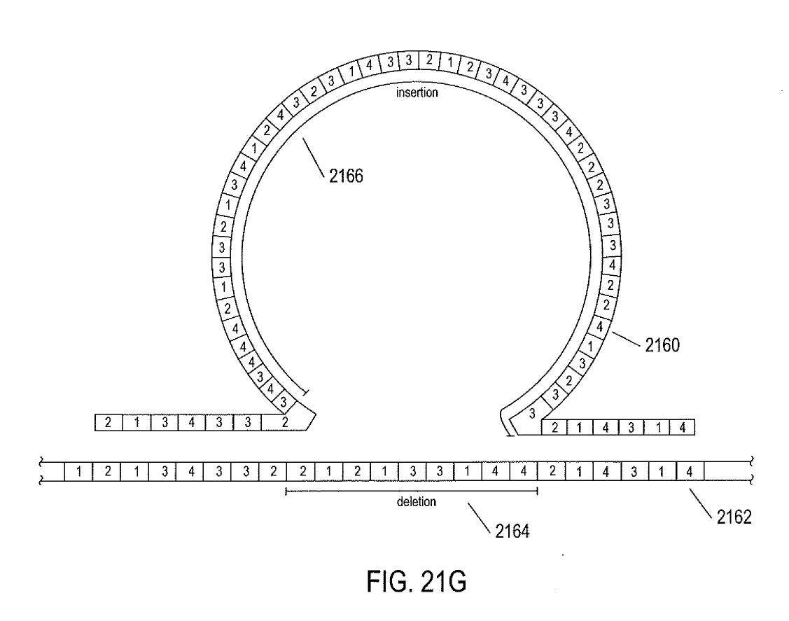

FIGS. 21A-G illustrate use corrected reads to assemble a variant symbol subsequence at a position of a reference symbol sequence. FIG. 21A shows a small set of 13 overlapping reads 2102-2114 that do not exactly match a reference sequence. Again, to be clear, FIG. 21B illustrates an overlap between reads 2105 and 2108 shown in FIG. 21A. In this case, four symbols of read 2105 overlap four symbols of read 2108. The overlap can be considered to have a weight of 4. The greater the weight associated with two overlapping reads, the greater the number of symbols of two reads that overlap.

FIG. 21C illustrates an anchor read. An anchor read 2120 includes a significant subsequence of symbols 2122 that exactly match a subsequence 2124 of a reference symbol sequence 2126. An anchor read also contains a significant subsequence of symbols 2128 that does not match or align with the reference symbol sequence. Thus, an anchor read represents a departure point between the symbol sequence from which a set of reads was generated and a reference symbol sequence. Anchor reads can be identified by commonly available alignment methods. Note than an anchor read may fully straddle a variant, in the case of short insertions an substitutions, and in the case of deletions.

FIG. 21D illustrates a read-overlap graph generated from the 13 reads shown in FIG. 21A. Note that each read is associated with an integer identifier, and the integer identifiers are used to uniquely name nodes in the read-overlap graph 2130. Each directed edge is associated with a weight that represents the number of symbols that overlap between the reads represented by nodes connected by the edge.

As shown in FIG. 21E, it is possible to start with an arbitrary node, such as node 2132 in read-overlap graph 2130 shown in FIG. 21D, and construct every possible sequence of overlapping reads that terminates, on both ends, with an anchor read. Two anchor reads 2113 and 2106 are represented by nodes 2134 and 2136 in the read-overlap graph 2130 shown in FIG. 21D. These nodes are indicated by “*” symbols. The anchor reads are identified by alignment procedures that align reads to a reference symbol sequence. FIG. 21E shows all possible traversal of the read-overlap graph 2130 that include read 2102 represented by node 2132. Were another read selected as a seed for determining the possible traversal paths that terminate at each end with anchor reads, in the present case, the same set of traversal paths would be obtained. Each traversal path, such as traversal path 2140, is associated with a score, such as score 2142 for traversal path 2140. The score is the lowest weight associated with any edge in the traversal path. In this small example, there are only two different scores “2” and “3.” The traversal paths with the maximum score of “3” are selected as candidate read assemblies. A secondary score, the average weight of the edges in the traversal graph, is also shown for those traversal paths with score “3.” Traversal paths 2144 and 2146 both have maximum scores, and are thus the two best candidates for a read assembly. In fact, they are equivalent.

FIG. 21F shows the assembly of the 13 reads shown in FIG. 21A consistent with the two best traversal paths 2144 and 2146 obtained from the read-overlap graph 2130 shown in FIG. 21D along a reference symbol sequence. FIG. 21G shows a consensus symbol sequence for a variant symbol sequence 2160 corresponding to the 13 reads shown in FIG. 21A and FIG. 21F aligned with the reference sequence 2162. Alignment of the variant symbol sequence 2160 with the reference symbol sequence 2162 shows that the variant is a hybrid variant comprising a deletion of a subsequence from the reference sequence 2164 and an insertion within the variant symbol sequence 2166.

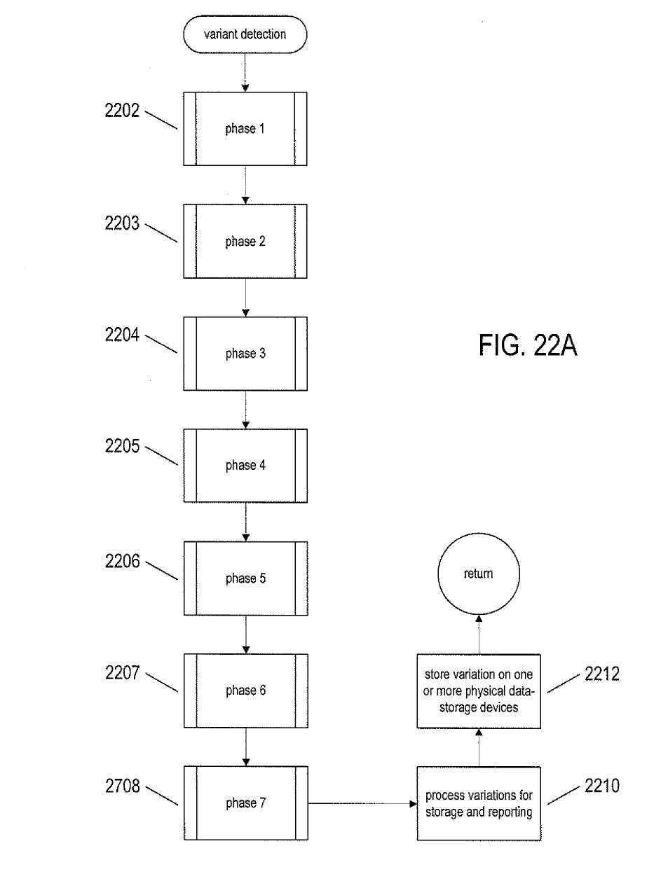

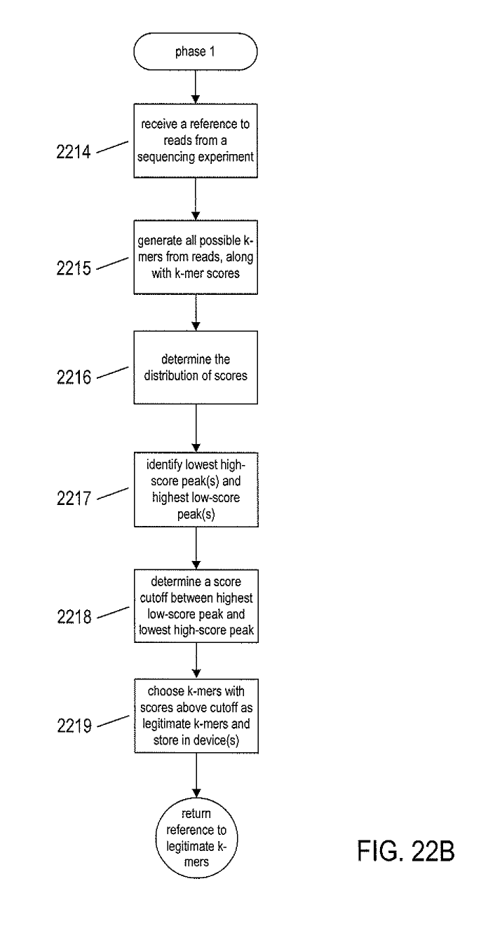

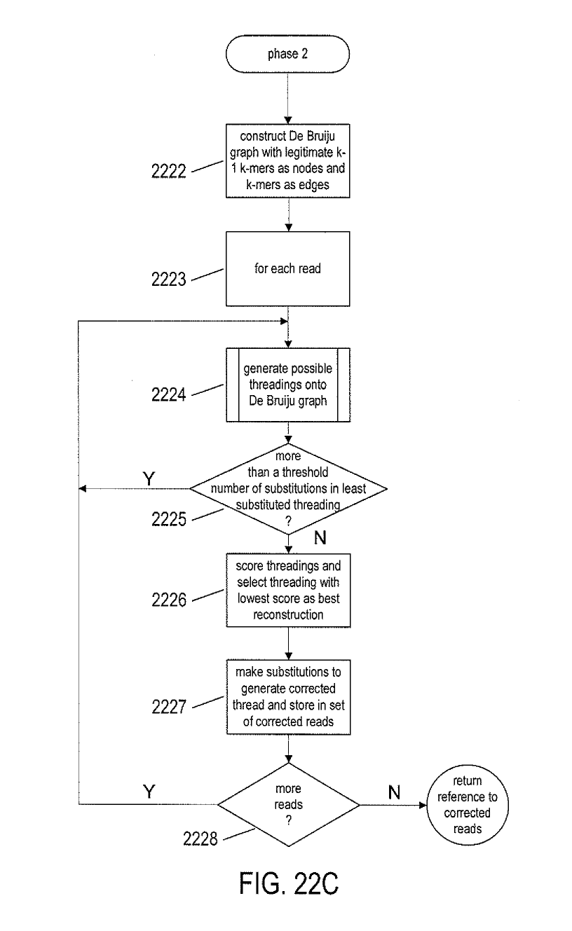

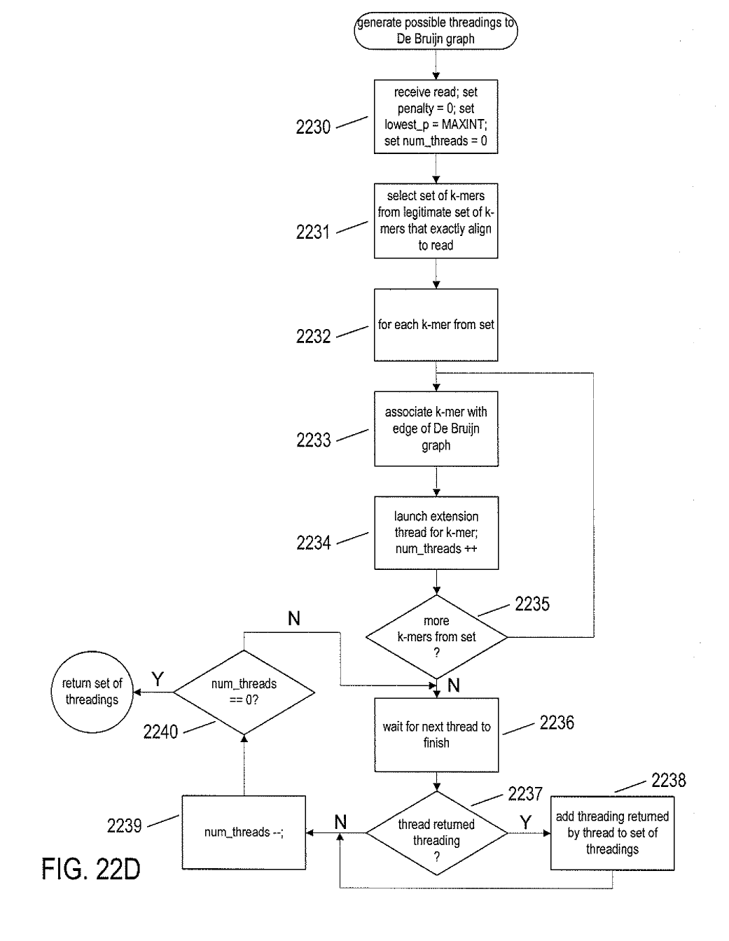

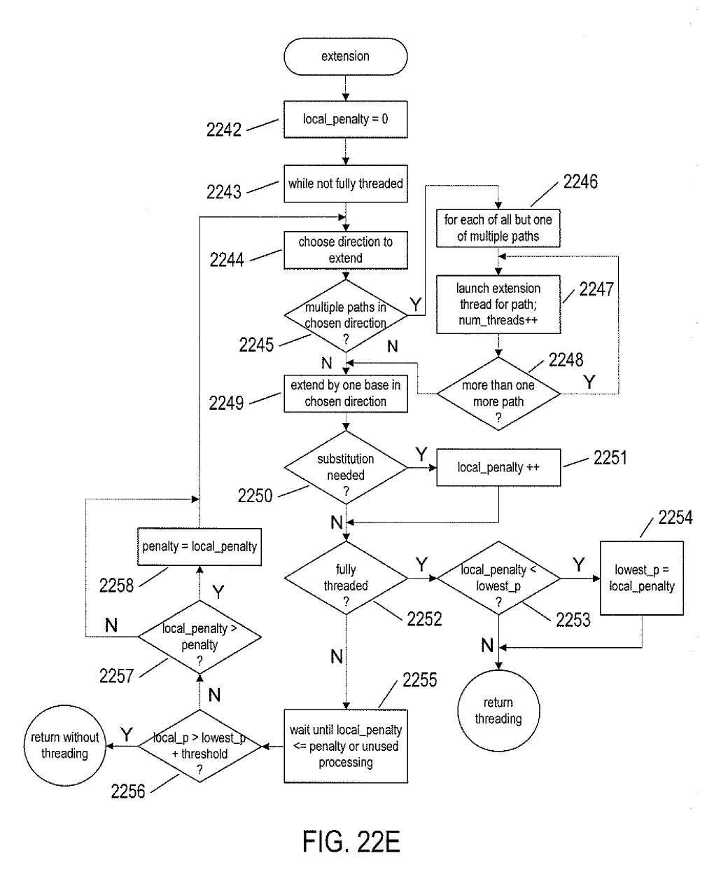

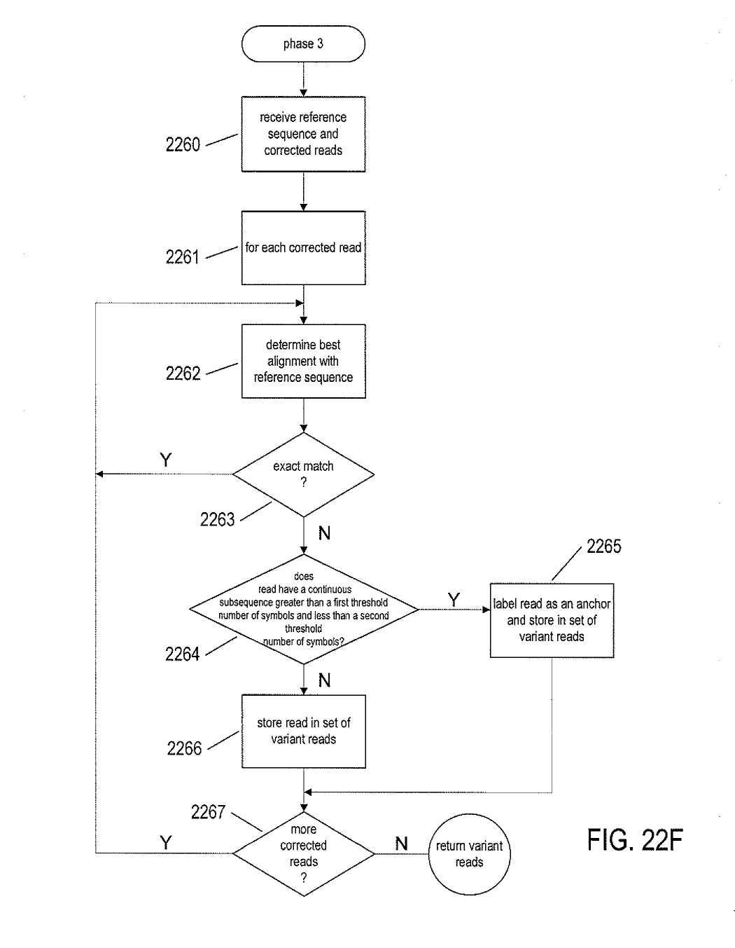

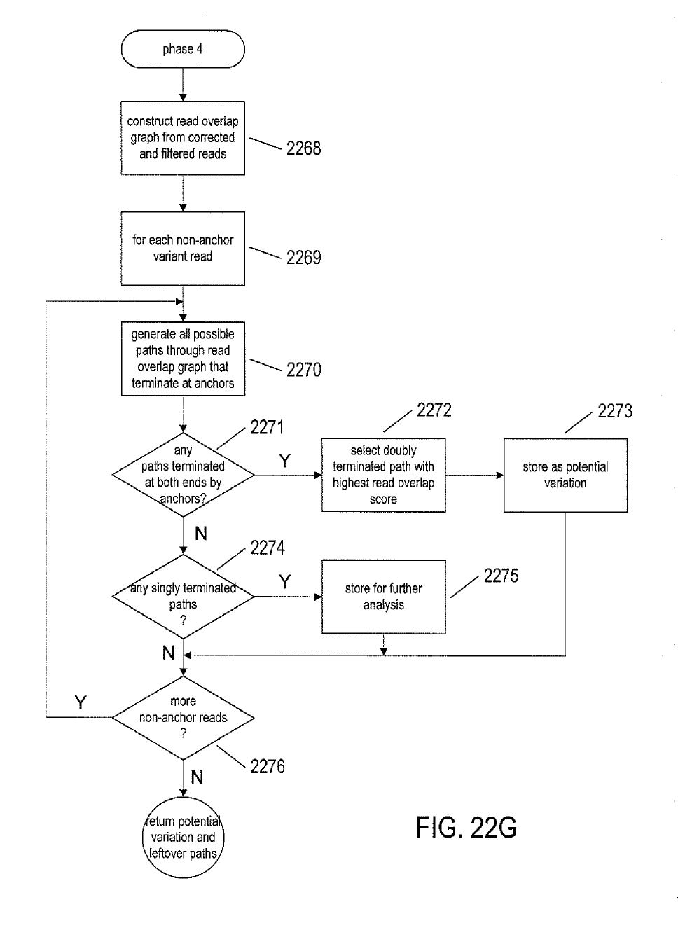

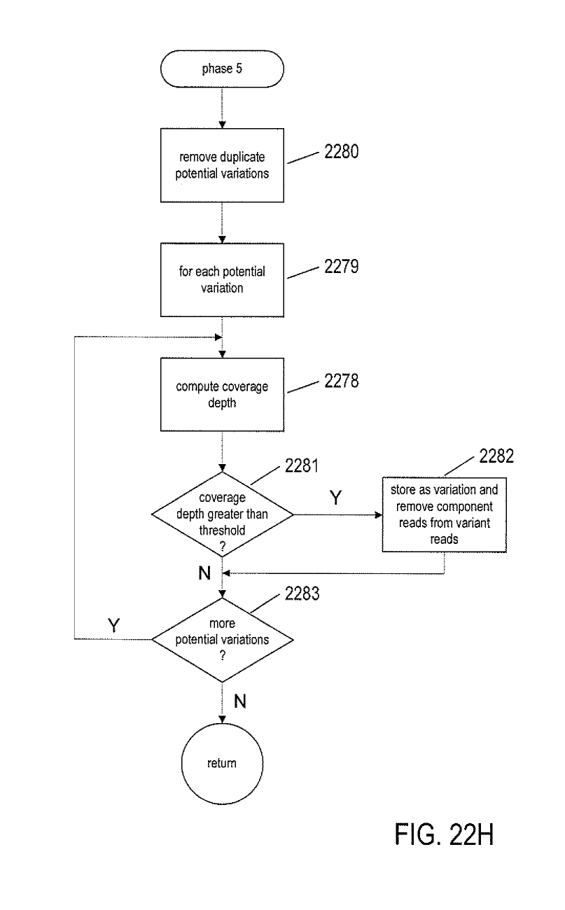

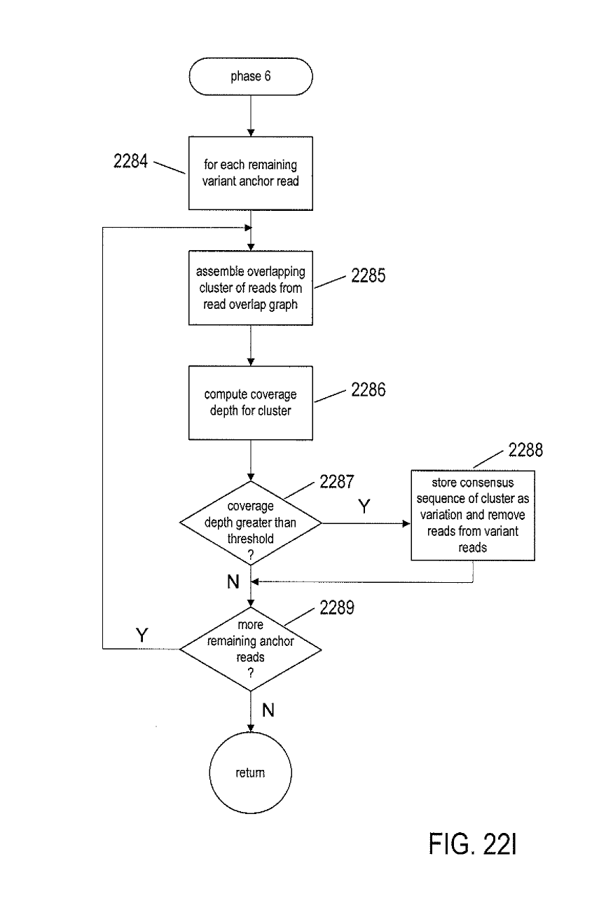

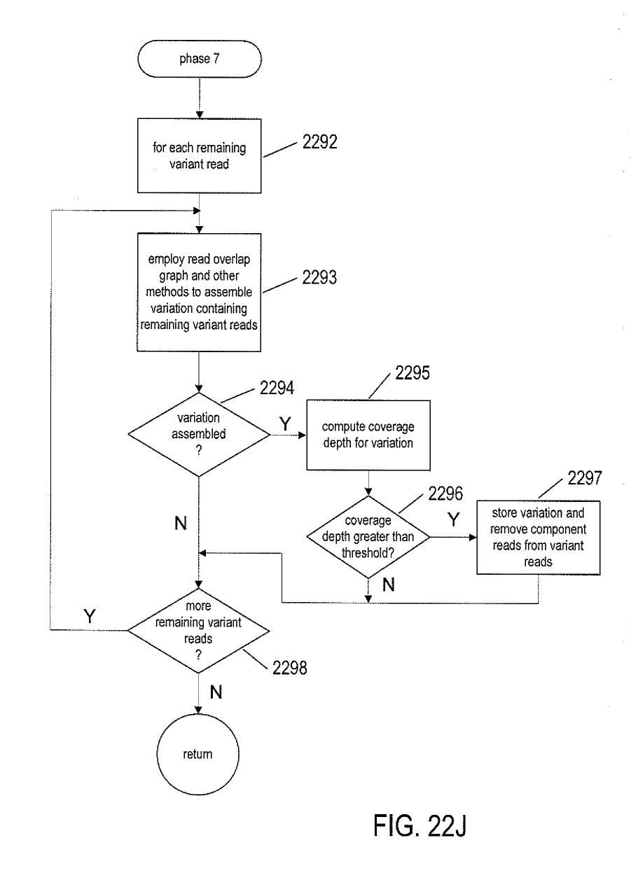

FIGS. 22A-J provide control-flow diagrams that illustrate a variant-detection control program that, when executed by one or more processors of a processor-controlled system, implement a method of variant detection to which the current document is directed. FIG. 22A shows a high-level control-flow diagram for a variant detection control program. The variant detection control program, in steps 2202-2208, calls seven routines that each implement one of seven different sequential phases of the variant-detection method. In a first phase, implemented by the routine “phase 1,” k-merization and k-mer filtering, as discussed above with reference to FIGS. 15-18, is carried out. In a second phase, implemented by the routine “phase 2,” a De Bruijn graph is constructed, as shown in FIG. 19A, and De-Bruijn-graph threading is used to correct the reads, as discussed above with reference to FIGS. 19B-20E. In a third phase, implemented by the routine “phase 3,” reads that exactly match a reference symbol sequence are filtered and removed from the set of corrected reads and the anchor reads, discussed above with reference to FIGS. 21B-21G, are identified. In a fourth phase, implemented by the routine “phase 4,” a read-overlap graph is constructed and various variant symbol sequences are assembled, as discussed above with reference to FIGS. 21A-G. In a fifth phase, implemented by the routine “phase 5,” the potential variant symbol sequences, identified by the routine “phase 4,” are filtered. In a sixth phase, implemented by the routine “phase 6,” additional candidate variant symbol sequences are identified and, in a seventh phase, implemented by the routine “phase 7,” additional candidate variant symbol sequences are filtered. In step 2210, the filtered variant symbol sequences identified in the seven phases are processed for storing in an electronic data-storage device and/or for display or reporting. In step 2212, the processed variant symbol sequences are stored in one or more physical data-storage devices.

FIG. 22B provides a control-flow diagram for the routine “phase 1,” called in step 2202 of FIG. 22A. In step 2214, a reference, or pointer, to a set of reads obtained from a sequencing procedure is received. In step 2215, the routine “phase 1” generates all possible k-mers from the received reads, and associates each with a k-mer quality score, as discussed above with reference to FIG. 15. In step 2216, a distribution of the k-mer quality scores is constructed, as discussed with reference to FIG. 18 and, in steps 2217 and 2218, a cutoff or threshold k-mer quality score is determined as a k-mer quality score midway between the lowest k-mer quality score of the broad peak and the highest k-mer quality score of the narrow peak, as also discussed with reference to FIG. 18. Finally, in step 2219, those k-mers with k-mer quality scores above the cutoff or threshold k-mer quality score are accepted as legitimate k-mers and stored in one or more physical data-storage devices.

FIG. 22C provides a control-flow diagram for the routine “phase 2,” called in step 2203 of FIG. 22A. In step 2222, the routine “phase 2” constructs a De-Bruijn graph with legitimate k-mers as directed edges and k-mers of length k−1, obtained from the legitimate j-mers, as nodes, as discussed above with reference to FIG. 19A. In the for-loop of steps 2223-2228, each read is processed. In step 2224, the currently considered read is processed, by threading discussed with reference to FIGS. 19B-20E, to generate all possible threadings with respect to the De-Bruijn graph constructed in step 2222. When the least substituted threading has more than a threshold number of symbol substitutions, as determined in step 2225, the read is discarded. Otherwise, the threading with the smallest cumulative symbol substitution score is selected, in step 2226, and any symbol substitutions in the threading are made to the currently considered read to generate a corresponding corrected read, in step 2227. The corrected reads are generally stored in one or more physical data-storage devices and a reference to the corrected reads is returned by the routine “phase 2.”

FIG. 22D provides a control-flow diagram for the routine, called in step 2224 of FIG. 22C, that generates all possible threadings of a read onto the De Bruijn graph generated in step 2222 of FIG. 22C. In step 2230, the read is received, a global variable penalty is set to 0, a global variable lowest-p is set to a large number, and a global variable num_threads is set to 0. Then, in step 2231, a set of k-mers that exactly align to the read is selected from the set of legitimate k-mers, produced by the routine “phase 1.” In the for-loop of steps 2232-2235, each k-mer from the set of selected k-mers is associated with an edge of the De Bruijn graph and an extension thread is launched, for the k-mer, to extend and thread the read onto the De Bruijn graph, in steps 2233-2234, as discussed above with reference to FIGS. 19B-G. The variable num_threads is incremented as each thread is launched, in step 2234. In step 2236, the routine waits for a next thread to finish execution. When the next finishing thread returns a threading for the read, as determined in step 2237, the threading is added to a set of threadings for the read in step 2238. In step 2239, the variable num_threads is decremented, to note completion of the thread, and, when num_threads is now 0, as determined in step 2240, the routine terminates returning the set of threadings.

FIG. 22E provides a control-flow diagram for the routine “extension,” executed by the threads launched in step 2234 of FIG. 20D. In step 2242, the routine “extension” sets a local variable local_penalty to 0. Then, in the while-loop of steps 2243-2258, the threading is extended. In step 2244, a direction is chosen for a next extension. The choice may be random or systematic. When multiple edges can be followed from a next node, as determined in step 2245 and as discussed with reference to FIG. 19G, additional threads are launched, in the for-loop of steps 2246-2248 for all but one of the multiple edges, with the current thread extending along the remaining edge. In step 2249, the threading is extended by one symbol in the chosen direction. When a substitution is need to extend the thread, as determined in step 2250, then the variable local_penalty is incremented. In alternative implementations, local_penalty may store the cumulative symbol-substitution score rather than the number of symbol substitutions. When the threading is now fully extended, as determined in step 2252, then, when the value stored in the local variable local_penalty is less than the value stored in the global variable lowest_p, as determined in step 2253, the value stored in the global variable lowest_p is set to the value stored in the local variable local_penalty, in step 2254. In this way, the global variable lowest_p reflects the lowest penalty yet observed for a fully extended threading. The threading is then returned. Otherwise, when the threading is not fully extended, as determined in step 2252, the thread waits until the value stored in the local variable local_penalty is less than or equal to the value stored in the global variable penalty, in step 2255, so that any threads with better current threadings can first proceed. When the value stored in the local variable local_penalty is greater than the value stored in the global variable lowest_p plus some threshold number, as determined in step 2256, the thread returns without returning a threading, since the threading already has less quality than a fully extended threading produced by another thread. Otherwise, when the value stored in the local variable local_penalty is greater than the value stored in the global variable penalty, as determined in step 2257, the value stored in the global variable penalty is set to the value stored in the local variable local_penalty, in step 2258. so that all threads know the highest penalty associated with a currently executing thread. In many systems, the various extension threads can execute in parallel. On other systems, only or a subset of the threads are scheduled for execution at any given time.

FIG. 22F provides a control-flow diagram for the routine “phase 3,” called in step 2204 of FIG. 22A. In step 2260, the routine “phase 3” receives a reference symbol sequence and a set of corrected reads. In the for-loop of steps 2261-2267, each corrected read is filtered and may be labeled as an anchor. In step 2262, the currently considered read is aligned in the best possible alignment to the reference symbol sequence, using any of various symbol-sequence-alignment methods. When the read exactly matches a subsequence of the reference symbol sequence, as determined in step 2263, the read is discarded. When the read has a continuous subsequence of symbols that exactly match a subsequence of the reference sequence greater than a first threshold number of symbols and less than a second threshold number of symbols, as determined in step 2264 and as discussed above with reference to FIG. 21C, the read is labeled as an anchor read and stored in a set of anchor reads. Otherwise the read is stored in a set of variant reads, in step 2266.

FIG. 22G provides a control-flow diagram for the routine “phase 4,” called in step 2205 of FIG. 22A. In step 2268, the routine “phase 4” constructs a read-overlap graph from the corrected and filtered reads, as discussed above with reference to FIG. 21D. Then, in the for-loop of steps 2269-2276, each non-anchor read is processed. In step 2270, all possible paths through the read-overlap graph that terminate at both ends in an anchor read are determined for the currently considered non-anchor read, as discussed above with reference to FIG. 21E. When such doubly terminated paths are found, as determined in step 2271, then the doubly terminated path with the highest read-overlap score is selected, in step 2272, and stored as a potential variant in step 2273. Otherwise, when any singly anchor-read-terminated paths are found, as determined in step 2274, then the singly anchor-read-terminated paths are stored for further analysis, in step 2275.

FIG. 22H provides a control-flow diagram for the routine “phase 5,” called in step 2206 of FIG. 22A. In step 2278, the routine “phase 5” removes any duplicate candidate variants stored by the routine “phase 4.” Then, in the for-loop of steps 2279-2282, the coverage depth for each variant is computed, in step 2280, and only when the coverage depth is greater than a threshold coverage depth, as determined in step 2281, is the variant candidate stored as a variant symbol sequence, in step 2282. The coverage depth is the average number of reads that overlap symbols of the variant symbol sequence. Some threshold coverage depth is expected for valid read assemblies, since, as discussed above with reference to FIG. 5, multiple copies of an initial symbol sequence containing variant symbol subsequences with respect to a reference sequence are generally sequenced to produce the set of reads that are processed by the currently disclosed method.

FIG. 22I provides a control-flow diagram for the routine “phase 6,” called in step 2207 of FIG. 22A. The routine “phase 6,” in the for-loop of steps 2284-2289, considers each remaining anchor read not already incorporated in a variant. When the anchor read can be assembled into a cluster of reads, from the read-overlap graph, and the coverage depth for the cluster is greater than a threshold coverage depth, then the cluster is stored as a variant, in step 2288.

FIG. 22J provides a control-flow diagram for the routine “phase 7,” called in step 2208 of FIG. 22A. In the for-loop of steps 2292-2298, the routine “phase 7” attempts to incorporate any remaining reads, including those incorporated within singly terminated paths, into additional variant symbol sequences. When they can be assembled in variant symbol sequences, as determined in step 2294, and when the coverage depth is sufficient, as determined in step 2296, they are stored as variants in step 2297. Many different alternative assembly techniques can be used, including a modified, multiple-sequence Smith-Waterman technique can be employed to assemble additional variant symbol sequences.

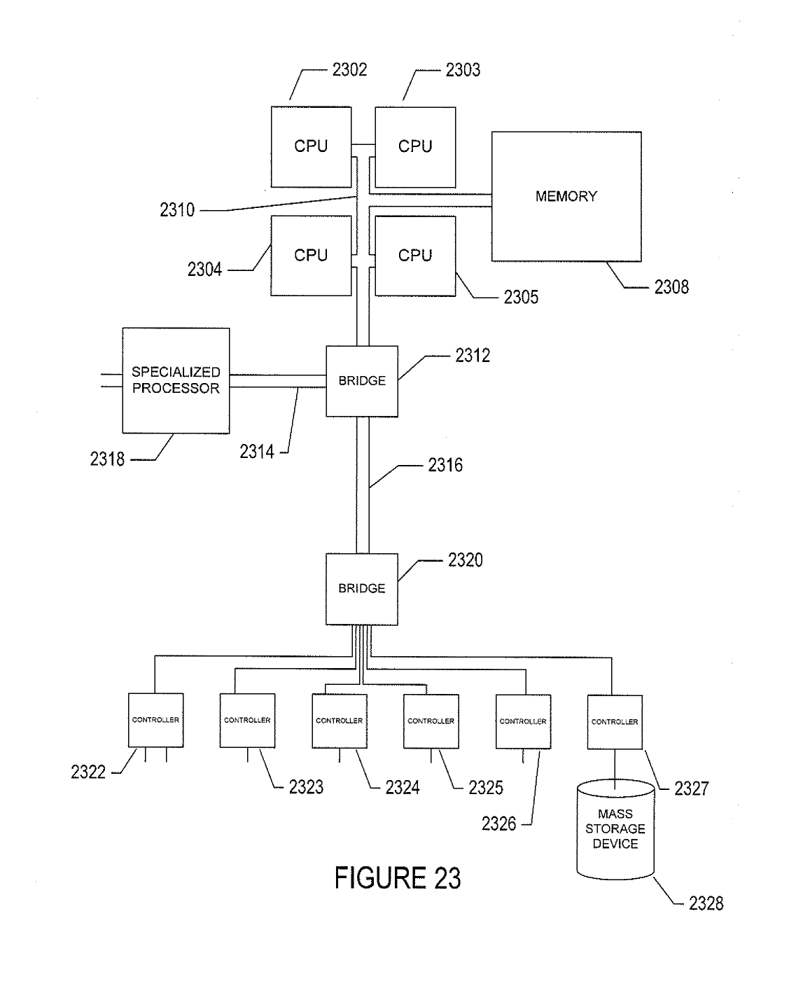

FIG. 23 provides a general architectural diagram for various types of computers and other processor-controlled devices. The high-level architectural diagram may describe a modern computer system used alone or together with other such systems as the processor-controlled system on which the currently described method is executed. The computer system contains one or multiple central processing units (“CPUs”) 2302-2305, one or more electronic memories 2308 interconnected with the CPUs by a CPU/memory-subsystem bus 2310 or multiple busses, a first bridge 2312 that interconnects the CPU/memory-subsystem bus 2310 with additional busses 2314 and 2316, or other types of high-speed interconnection media, including multiple, high-speed serial interconnects. These busses or serial interconnections, in turn, connect the CPUs and memory with specialized processors, such as a graphics processor 2318, and with one or more additional bridges 2320, which are interconnected with high-speed serial links or with multiple controllers 2322-2327, such as controller 2327, that provide access to various different types of mass-storage devices 2328, electronic displays, input devices, and other such components, subcomponents, and computational resources.

Although the present invention has been described in terms of particular embodiments, it is not intended that the invention be limited to these embodiments. Modifications within the spirit of the invention will be apparent to those skilled in the art. For example, any of many different possible implementations of the data structures and methods used for variant-symbol-sequence detection may be obtained by varying any of many different design and implementation parameters, including data structures, control structures, modular organization, programming language, underlying operating system and hardware, and many other such design and implementation parameters. Any of various different k-mer quality scores, related to the above described k-mer quality score, any of various different cumulative k-mer-quality scores related to the above described cumulative k-mer-quality score, any of various different cumulative symbol-substitution scores related to the above described cumulative symbol-substitution score, and any of various different read-overlap scores, related to the above described read-overlap score, may be used in various alternative implementations.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A variant-symbol-sequence detection system comprising:
one or more processors;
one or more data-storage devices; and
computer instructions, stored in one or more of the one or more data-storage devices that, when executed by one or more of the one or more processors, control the variant-symbol-sequence detection system to:
receive a set of read symbol sequences generated from multiple copies of an initial symbol sequence,
k-merize the read symbol sequences to generate a set of unique k-mers, each unique k-mer of the set associated with a k-mer quality score;
filter the set of unique k-mers to remove k-mers likely to contain erroneous symbols in order to generate a set of legitimate k-mers;
correct erroneous symbols within the read symbol sequences using the set of legitimate k-mers to generate a set of corrected read symbol sequences;
filter the set of corrected read symbol sequences to remove corrected read symbol sequences that exactly match subsequences within a reference symbol sequence to generate a set of variant read symbol sequences; and
assemble the variant read symbol sequences into one or more variant symbol sequences.

2. The variant-symbol-sequence detection system of claim 1 wherein the variant-symbol-sequence detection system k-merizes the read symbol sequences by:
for each read symbol sequence in the set of read symbol sequences,
generating each subsequence of the read symbol sequence of a length k, where k has a value smaller than the length of the smallest read symbol sequence, as a k-mer of the read symbol sequence, and
computing, for each k-mer of the read symbol sequence, a k-mer quality score as −10 times the logarithm of the product of probabilities associated with each symbol in the read symbol sequence corresponding to a symbol in the k-mer being correct.

3. The variant-symbol-sequence detection system of claim 2 wherein the variant-symbol-sequence detection system generates a set of unique k-mers, each unique k-mer of the set associated with a cumulative k-mer quality score, by:
selecting a set of unique k-mers corresponding to k-mers generated for the read symbol sequences, each k-mer in the set of unique k-mers associated with a count and with a cumulative k-mer quality score that is computed as the sum of the k-mer quality scores of the instances of the k-mer generated for the read symbol sequences.

4. The variant-symbol-sequence detection system of claim 1 wherein the variant-symbol-sequence detection system filters the set of unique k-mers to remove k-mers likely to contain erroneous symbols in order to generate a set of legitimate k-mers by:
determining a bimodal distribution of cumulative k-mer quality scores for the set of unique k-mers;
determining a cutoff cumulative k-mer quality score from the bimodal distribution; and
accepting as legitimate k-mers those k-mers associated with cumulative k-mer quality scores greater than the cutoff cumulative k-mer quality score.

5. The variant-symbol-sequence detection system of claim 4 wherein determining a cutoff cumulative k-mer quality score from the bimodal distribution further includes determining a cumulative k-mer quality score midway between the largest cumulative k-mer quality score of a first, narrow, low-cumulative-k-mer-quality-score peak and the smallest cumulative k-mer quality score of a second, broad, high-cumulative-k-mer-quality-score peak in the bimodal distribution.

6. The variant-symbol-sequence detection system of claim 1 wherein the variant-symbol-sequence detection system corrects erroneous symbols within the read symbol sequences using the set of legitimate k-mers to generate a set of corrected read symbol sequences by:
constructing a De Bruijn graph from the set of legitimate k-mers, wherein each directed edge in the De Bruijn graph represents a legitimate k-mer of length k and each node in the De Bruijn graph represents a k-mer of length k−1 that is a prefix or suffix of a legitimate k-mer;
for each read symbol sequence,
threading the read symbol sequence onto the De Bruijn graph to generate possible overlapping assemblies of legitimate k-mers that generate the read symbol sequence, and
selecting a lowest scored threading as a correct symbol sequence corresponding to the read symbol sequence.

7. The variant-symbol-sequence detection system of claim 6 wherein threading the read symbol sequence onto the De Bruijn graph to generate possible overlapping assemblies of legitimate k-mers that generate the read symbol sequence further includes:
for each threading,
computing a cumulative symbol-substitution score based on quality scores of symbols in the read sequence that are replaced in the threading with alternative symbols.

8. The variant-symbol-sequence detection system of claim 6 wherein selecting a lowest scored threading as a correct symbol sequence corresponding to the read symbol sequence further comprises:
selecting the threading with the lowest cumulative symbol-substitution score.

9. The variant-symbol-sequence detection system of claim 1 wherein the variant-symbol-sequence detection system assembles the variant read symbol sequences into one or more variant symbol sequences by:
identifying anchor read symbol sequences from the set of variant read symbol sequences;
generating a read-overlap graph;
generating paths through the read-overlap graph; and
selecting, as candidate variant symbol sequences, paths that terminate at each end with anchor read symbol sequences.

10. The variant-symbol-sequence detection system of claim 9 further comprising:
selecting, as variant symbol sequences, those candidate variant symbol sequences with greater than a threshold coverage depth.

11. The variant-symbol-sequence detection system of claim 9 wherein anchor read symbol sequences are read symbol sequences that contain a symbol subsequence that exactly matches a symbol subsequence of the reference symbol subsequence.

12. The variant-symbol-sequence detection system of claim 11 wherein the symbol subsequence that exactly matches a symbol subsequence of the reference symbol subsequence has greater than a first threshold number of symbols and less than a second threshold number of symbols.

13. The variant-symbol-sequence detection system of claim 9 wherein selecting, as candidate variant symbol sequences, paths that terminate at each end with anchor read symbol sequences further comprises:
selecting, as a candidate variant symbol sequence, a path that includes a corrected read symbol sequence among the paths that include the corrected read symbol sequence that both terminates at each end with anchor read symbol sequences and that has a highest read-overlap score of the paths that include the corrected read symbol sequence.

14. The variant-symbol-sequence detection system of claim 13 wherein the read-overlap score is the lowest overlap between read symbol sequences along the path.

15. A method for variant-symbol-sequence detection carried out in a system having one or more processors and one or more data-storage devices, the method comprising:
receiving a set of read symbol sequences generated from multiple copies of an initial symbol sequence,
k-merizing the read symbol sequences to generate a set of unique k-mers, each unique k-mer of the set associated with a k-mer quality score;
filtering the set of unique k-mers to remove k-mers likely to contain erroneous symbols in order to generate a set of legitimate k-mers;
correcting erroneous symbols within the read symbol sequences using the set of legitimate k-mers to generate a set of corrected read symbol sequences;
filtering the set of corrected read symbol sequences to remove corrected read symbol sequences that exactly match subsequences within a reference symbol sequence to generate a set of variant read symbol sequences; and
assembling the variant read symbol sequences into one or more variant symbol sequences.

16. The method of claim 15 wherein k-merizing the read symbol sequences further comprises:
for each read symbol sequence in the set of read symbol sequences,
generating each subsequence of the read symbol sequence of a length k, where k has a value smaller than the length of the smallest read symbol sequence, as a k-mer of the read symbol sequence, and
computing, for each k-mer of the read symbol sequence, a k-mer quality score as −10 times the logarithm of the product of probabilities associated with each symbol in the read symbol sequence corresponding to a symbol in the k-mer being correct.

17. The method of claim 16 wherein generating a set of unique k-mers, each unique k-mer of the set associated with a cumulative k-mer quality score, further comprises:
selecting a set of unique k-mers corresponding to k-mers generated for the read symbol sequences, each k-mer in the set of unique k-mers associated with a count and with a cumulative k-mer quality score that is computed as the sum of the k-mer quality scores of the instances of the k-mer generated for the read symbol sequences.

18. The method of claim 15 wherein filtering the set of unique k-mers to remove k-mers likely to contain erroneous symbols in order to generate a set of legitimate k-mers further comprises:
determining a bimodal distribution of cumulative k-mer quality scores for the set of unique k-mers;
determining a cutoff cumulative k-mer quality score from the bimodal distribution; and
accepting as legitimate k-mers those k-mers associated with cumulative k-mer quality scores greater than the cutoff cumulative k-mer quality score.

19. The method of claim 18 wherein determining a cutoff cumulative k-mer quality score from the bimodal distribution further includes determining a cumulative k-mer quality score midway between the largest cumulative k-mer quality score of a first, narrow, low-cumulative-k-mer-quality-score peak and the smallest cumulative k-mer quality score of a second, broad, high-cumulative-k-mer-quality-score peak in the bimodal distribution.

20. The method of claim 15 wherein correcting erroneous symbols within the read symbol sequences using the set of legitimate k-mers to generate a set of corrected read symbol sequences further comprises:
constructing a De Bruijn graph from the set of legitimate k-mers, wherein each directed edge in the De Bruijn graph represents a legitimate k-mer of length k and each node in the De Bruijn graph represents a k-mer of length k−1 that is a prefix or suffix of a legitimate k-mer;
for each read symbol sequence,
threading the read symbol sequence onto the De Bruijn graph to generate possible overlapping assemblies of legitimate k-mers that generate the read symbol sequence, and
selecting a lowest scored threading as a correct symbol sequence corresponding to the read symbol sequence.

21. The method of claim 20 wherein threading the read symbol sequence onto the De Bruijn graph to generate possible overlapping assemblies of legitimate k-mers that generate the read symbol sequence further includes:
for each threading,
computing a cumulative symbol-substitution score based on quality scores of symbols in the read sequence that are replaced in the threading with alternative symbols.

22. The method of claim 20 wherein selecting a lowest scored threading as a correct symbol sequence corresponding to the read symbol sequence further comprises:
selecting the threading with the lowest cumulative symbol-substitution score.

23. The method of claim 15 wherein assembling the variant read symbol sequences into one or more variant symbol sequences further comprises:
identifying anchor read symbol sequences from the set of variant read symbol sequences;
generating a read-overlap graph;
generating paths through the read-overlap graph; and
selecting, as candidate variant symbol sequences, paths that terminate at each end with anchor read symbol sequences.

24. The method of claim 23 further comprising:
selecting, as variant symbol sequences, those candidate variant symbol sequences with greater than a threshold coverage depth.

25. The method of claim 23 wherein anchor read symbol sequences are read symbol sequences that contain a symbol subsequence that exactly matches a symbol subsequence of the reference symbol subsequence.

26. The method of claim 25 wherein the symbol subsequence that exactly matches a symbol subsequence of the reference symbol subsequence has greater than a first threshold number of symbols and less than a second threshold number of symbols.
